(19) United States
(12) Patent Application Publication
(10) Pub. No.: US 2018/0013709 A1
(43) Pub. Date: Jan. 11, 2018

(54) Message Identification, Processing, and monitoring Systems and Methods For Communications Commerce

(71) Applicant: 5TH DIMENSION LLC, Mt. Pleasant, SC (US)

(72) Inventor: Keith James PITTNER, Mt. Pleasant, SC (US)

(21) Appl. No.: 15/506,739

(22) PCT Filed: Aug. 31, 2015
(86) PCT No.: PCT/US2015/047671

§ 371 Date: Feb. 26, 2017

(51) Int. Cl. H04L 12/58; H04W 4/14

(52) U.S. Cl. CPC H04L 51/28; H04W 4/14; H04L 51/02; H04L 51/38

(57) ABSTRACT

Systems and methods are provided for embedding a sender's unique identification in a digital message, for providing additional communication data to a recipient device, and for controlling communications between the sender and multiple recipients and among those recipients depending on the sender's preferences, among other embodiments.

### COPYRIGHT NOTICE

A portion of the disclosure of this patent document contains material which is subject to copyright protection. The Copyright owner has no objection to the facsimile reproduction by anyone of the patent document or the patent disclosure, as it appears in the U.S. Patent and Trademark Office patent file or records, but otherwise reserves all copyright rights whatsoever.

### CROSS-REFERENCE TO RELATED APPLICATIONS

This application claims benefit of U.S. Provisional Patent Application Ser. No. 62/044,182, also entitled, “MESSAGE IDENTIFICATION, PROCESSING, AND MONITORING SYSTEMS AND METHODS FOR COMMUNICATIONS COMMERCE,” filed in the United States Patent and Trademark Office on Aug. 29, 2014, which is incorporated herein by reference in its entirety.

### BACKGROUND OF THE DISCLOSURE

Sending or receiving alphanumeric messages to or from communications devices is commonly known as text messaging or “texting” and is based on a protocol known as Short Message Service (SMS). SMS text messages may include up to 160 characters, due in part to signaling formats that existed during SMS concept development in the early 1980s. Modern texting may also include multimedia content based on Multimedia Messaging Service (MMS) protocol.

Conventional texting suffers from a variety of drawbacks. For instance, a mobile communications device, such as a cellular telephone (“cell phone”) or “smartphone”, may be lost or damaged beyond recovery. Text messages that reside on the defunct smartphone may be practically impossible to recover. Likewise, if a user simply decides to replace or upgrade the smartphone, a memory card must be used to transfer the text messages to a new phone. Additionally, conventional texting restricts the user to texting via the smartphone rather than on a desktop computer, for instance. Still further, when a text arrives at the smart phone, unless the user has downloaded an application from the sender or has the sender information in a contact list, notification of the text message will be indicated with a nondescript number, which is often not a recognizable telephone number. A further drawback with conventional texting is that even when the user is communicating with another user within the same network, the text message must be routed through a communications carrier, and the text is charged against data plans of the users. Additionally, a user cannot monitor texts of another user, such as a parent monitoring the texts of a child, in real time and not without having to download a monitoring application or needing to access the monitored account through the carrier.

More than just another texting application, the industry needs an engagement platform that allows people to stay connected to what is important. What is needed in the communications industry is a system that: provides texting from any communications device; provides transfer of text messages to another device in the event of damage or loss to an original device; enables a sender to identify its text with a recognizable name, logotype (“logo”) or the like regardless of a recipient device set-up; provides texting to-from users while bypassing carrier involvement; and permits real-time monitoring of texts.

### BRIEF SUMMARY OF THE DISCLOSURE

Unexpectedly, Applicant has invented systems, devices, and methods that provide an engagement platform that allows an entity to establish a unique identity and to communicate with a community of its own design using that unique identity. Any suitable entity can use this engagement platform: a family, a circle of friends, a professor and her classroom of students, a little-league coach and his team of players and parents, nonprofit organizations, news outlets and social media providers, governments disseminating emergency and public service announcements, and companies that need to connect to their customers, employees, vendors, and other stakeholders. The present disclosure is directed in general to engagement platform systems and processes that: provide texting from any communications device, including computers, tablets, mobile telephones and the like; provide for transfer of data including text messages to another device even if an original device is lost or destroyed; enable a sender to uniquely identify or “tag” its text with a recognizable or “friendly” name, logo or the like without regard to a contact list or sender application on a receiving device; provide texting between users in the same system network without involving data plans or wireless plan carriers; and permit a first user to monitor texts of a second user in real time without need for a monitoring application or access to a communications account.

According to one embodiment of the present disclosure, a system for assigning unique Mobile Domain Names (MDN) to digital content on a communications network may include a text application server being configured to manage digital content by: generating unique MDNs; populating a database of the unique MDNs; receiving incoming connections from a web socket in electronic communication with the communications network, at least one of the incoming connections carrying a message service structure (MSS) associated with one of the unique MDNs; identifying a unique MDN from the database as an associated MDN and assigning the associated MDN to the MSS; configuring the MSS to form a configured MSS so that the associated MDN is displayed on a communications device when the configured MSS is displayed on the communications device; and sending the configured MSS to the communications device.

In this embodiment, the unique MDN may be a logotype, a name, and the like. The MSS is a short message service (SMS) message and/or a multimedia message service (MMS) and is addressed to the communications device. In this aspect, the MSS may be configured to be received by a communications device chosen from a personal computer, a smartphone, and/or another mobile communication apparatus.

The database of unique MDNs may include a user profile for each unique MDN. The user profile may include a symbol, a logotype, a name, and/or a mark. Additionally, the user profile may include broadcast and reply options.

The system in this embodiment may also include a resolution application also known as a 5th Dimension Core application. The 5th Dimension Core application may be configured to resolve the MSS and also to display the associated MDN on the various communications devices.

Some embodiments may also provide an integrated display including a conversation list integrating the MDN and an SMS message. Still further, the integrated display may include a conversation list integrating the MDN and an MMS message. See, for example, FIG. 27.

In some embodiments the 5th Dimension Core application can dictate response options to an MSS message, such as no response, a group response, or a private response. The configured MSS may be sent to the communications device via an outgoing connection provided by one or more web sockets in electronic communication with the communications network.

In another embodiment a system is provided for assigning discrete identifiers to digital content on a communications network, which may include a resolution application (such as 5th Dimension Core) configured to assimilate a communications device by intercepting and disassembling an MSS addressed to the communications device. The 5th Dimension Core application may be further configured to resolve a text identifier associated with the MSS.

In one aspect, the text identifier may be an MDN. In other aspects, the text identifier may not include an MDN. In further aspects, the 5th Dimension Core application can identify an MSS carrying the MDN.

Also in this embodiment, a server such as a 5th Dimension Core server may be included which is configured to identify an MSS containing an MDN. More specifically, the 5th Dimension Core server will be in communication with the 5th Dimension Mobile Application in order to display the MDN on the communications device.

In a further aspect, the embodiment may include an MDN server configured to associate an MSS having an associated MDN to the associated MDN's symbol, logotype, name, and/or mark.

In a further embodiment, a system for assigning unique MDNs to digital content on a communications network may include a text application server configured to manage digital content by generating unique MDNs such that no two MDNs are identical; a database of the unique MDNs; and a resolution application (e.g., 5th Dimension Mobile Application) being configured to assimilate a communications device by disassembling a message service structure (MSS) addressed to the communications device, the 5th Dimension Mobile Application being further configured to resolve a text identifier associated with the MSS.

According to the disclosure, a method for managing digital content on a communications network may include providing a text application server being configured to manage digital content by generating unique MDNs such that no two unique MDNs are identical; providing a database of the unique MDNs; providing a resolution application (5th Dimension Mobile Application) being configured to assimilate a communications device by disassembling a message service structure (MSS) addressed to the communications device, the 5th Dimension Mobile Application being further configured to resolve a MSS having an associated MDN and process a MSS that does not have an associated MDN; providing a 5th Dimension Core application server and identifying a MSS from a sender communications device having the 5th Dimension Mobile Application, the 5th Dimension Core application server being configured to recognize whether a receiver communications device has a companion 5th Dimension Mobile Application; identifying whether the MSS from the sender communications device includes an associated MDN or is a non-MDN MSS, wherein, if the receiver communications device has the companion 5th Dimension Mobile Application and the MSS from the sender is a non-MDN MSS, the MSS from the sender communications device is processed by the 5th Dimension Core application server, and wherein if the MSS from the sender communications device includes an associated MDN, the message from the sender communications device is sent to the MDN application server for processing.

The method may also include archiving the MSS having an associated MDN to the database. Still further, the 5th Dimension Core Application server may also include one or more instructions that cause a processor to perform the operations of: registering the message from the sender; and storing user profile data in a database accessible by the MDN application, the database having a discrete identifier linked to the message from the sender.

The method may also provide for a module for detecting an online presence of the communications device. A 5th Dimension Core network may also be provided that permits real-time monitoring of texts to or from the communications device by another communications device in the 5th Dimension Core network. Additionally, or alternatively, a 5th Dimension Core network may enable texting between the communications device and another communications device within the 5th Dimension Core network.

A system for resolving a message service structure (MSS) comprising a resolution application (5th Dimension Mobile Application) is also disclosed. The 5th Dimension Mobile Application may be configured to resolve the MSS to form a resolved MSS and display an associated MDN with the resolved MSS on a communications device. The 5th Dimension Mobile Application may be configured to display a conversation list integrating the associated MDN message with the resolved MSS. The resolved MSS may be a multimedia message service message (MMS) and/or a short message service message (SMS).

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a flowchart showing a subscription process for a unique text identifier service according to an aspect of the disclosure;

FIG. 2 is a flowchart of a continuation of the process as in FIG. 1;

FIG. 3 is a flowchart of a setup and configuration process for the text identifier and related options pursuant to the process in FIGS. 1 and 2;

FIG. 4 is an exemplary administrative management screen provided to a brand or name owner for configuring the text identifier and for managing communication options as in FIG. 3;

FIG. 5 is a diagram of components related to the unique text identifier service as in FIGS. 1 and 2;

FIG. 6 is a diagram illustrating an exemplary text identifier service database protocol;

FIG. 7 is a diagram of exemplary communication options relative to the unique text identifier service;

FIG. 8 a diagram related to the system in FIG. 5 further showing client user applications and interaction among servers;

FIG. 9 a diagram related to unique text identifier server as in FIG. 8 particularly showing an exemplary broadcast configuration;

FIG. 10 a diagram related to unique text identifier server as in FIG. 8 particularly showing an exemplary broadcast-reply configuration;

FIG. 11 is an illustration of a subscription management process and end-user device protocols related to FIGS. 1-5;

FIG. 12 is diagram relative to FIG. 5 showing inter-server communications among application servers and further illustrating multiple connections to-from the application servers;

FIG. 13 is a flow chart depicting a process for an end-user subscription to the text identifier service according to another aspect of the disclosure;

FIG. 14 is an illustration of content handling between communication devices and servers based on applications on end-user devices relative to FIG. 7;

FIG. 15 is another illustration of content handling between communication devices and servers based on a device application relative to FIG. 7;

FIG. 16 is an illustration of text message handling between communication devices and servers based on complementary applications on respective end-user devices;

FIG. 17 is an illustration of text message handling between communication devices and servers based on application presence;

FIG. 18 is an illustration of text message handling protocols between unique text identifier servers and end-user servers;

FIG. 19 is a diagram illustrating message origination and handling protocols between unique text identifier servers and end-user servers;

FIGS. 20A and 20B are diagrams illustrating message processes and communication protocols;

FIG. 21 is a diagram illustrating client to server communication protocol;

FIG. 22 is an exemplary screenshot of a device displaying an exemplary installation set-up function relative to FIG. 13;

FIG. 23 is an exemplary screenshot of a device displaying a point in an installation set-up relative to FIGS. 13 and 22;

FIG. 24 is an exemplary screenshot of a device displaying monitoring or texting options;

FIG. 25 is an exemplary screenshot of a device showing accounts being monitored;

FIG. 26 is an exemplary screenshot of a device showing a monitor request screen;

FIG. 27 is an exemplary screenshot of a device displaying a monitoring account screen showing an account conversation post monitoring function;

FIG. 28 is a diagram illustrating an exemplary process for an entity to embed a unique identifier in a text message conversation list relative to FIG. 3;

FIG. 29 is a diagram illustrating another exemplary process for an entity to embed a unique identifier in a text message conversation list relative to FIG. 3;

FIG. 30 is a flow chart depicting a process for a user to join the unique text identifier service according to another aspect of the disclosure that may result in the exemplary screenshot as in FIG. 27;

FIG. 31 a flow chart depicting another process in which a user joins a text identifier service similar to FIG. 30 but without an end-user application installed on a device;

FIG. 32 is a flow chart depicting a process for storing a list of conversations on a device resulting in the exemplary screenshot as in FIG. 27 according to another aspect of the disclosure;

FIG. 33 is a flow chart depicting a process for constructing a list of conversations on a device that may result in the exemplary screenshot as in FIG. 27 according to another aspect of the disclosure;

FIG. 34 is a flow chart showing a process involving a unique text identifier subscription and a default SMS capability according to another aspect of the disclosure;

FIG. 35 is a flow chart of a process for real-time monitoring with end-user device applications installed according to another aspect of the disclosure;

FIG. 36 is a flow chart showing an exemplary result of the process for real-time monitoring as in FIG. 35;

FIG. 37 is a flowchart of a process for mapping a storage structure of a device according to a further aspect of the disclosure;

FIG. 38 is a flowchart of a process for transferring data to a new device according to a mapping aspect as in FIG. 37;

FIG. 39 is a chart showing a sampling of exemplary device field structures;

FIG. 40 is flowchart showing an availability search according to an aspect of the disclosure;

FIG. 41 is a flowchart related to FIG. 40 showing selection of a mobile domain name according to another aspect of the disclosure;

FIG. 42 is a diagram illustrating a mobile domain name lock time controller according to a further aspect of the disclosure;

FIG. 43 is a flowchart showing a mobile domain name engagement time controller according to another aspect of the disclosure;

FIG. 44 is an exemplary screenshot of a device showing a dashboard according to an aspect of the disclosure;

FIG. 45 is an image of a dashboard showing a set-up configuration according to another aspect of the disclosure;

FIGS. 46A and 46B are screenshots of an engagement builder according to a further aspect of the disclosure;

FIGS. 47A and 47B are screenshots of an engagement builder particularly showing selected trivia images according to another aspect of the disclosure;

FIGS. 48A-48D are related to FIGS. 47A and 47B and show interactive device screens according to another aspect of the disclosure;

FIG. 49 is related to FIGS. 47A-48D showing an exemplary Broadcast Only screenshot;

FIGS. 50A and 50B are screenshots of a dashboard builder particularly showing barcode images according to another aspect of the disclosure;

FIGS. 51A and 51B are exemplary screenshots of, respectively voice and audio images according to a further aspect of the disclosure;

FIG. 52 shows an exemplary screenshot of an audio message sub-thread;

FIG. 53 shows an exemplary screenshot of a mobile application monitor;

FIG. 54 shows an exemplary tablet device screenshot; and

FIG. 55 shows an exemplary screenshot of a core display website according to a further aspect of the disclosure.

### DETAILED DESCRIPTION OF THE DISCLOSURE

In general, the present disclosure provides systems and methods for improving operations and functionality of devices such as hand-held cellular telephones, desktop computers, laptops, tablets, pads and the like, and for improving marketing and advertising by providing additional and improved communication data to a recipient and by providing data management controls to a business or brand owner to manage displays on a recipient device.

In the detailed description that follows various terms and acronyms are used, including the following:

API. An application-programming interface, which is a set of programming instructions and standards for accessing a software application via the Internet. Typically, a software company will publish or release its API to the public for other software developers to design products to exploit the software application.

Application Program. Within the context of computer hardware and software, an application program is a set of one or more computer programs that performs a function when executed within a computer hardware device. If the set is comprised of multiple programs, the programs are coordinated to perform a function together but such programs may individually perform other functions. Similarly, a program may be comprised of multiple modules that perform certain functions individually and other functions when combined in various ways.

Communications device(s). Any electronic device having a screen and an interactive interface such as a keyboard or touchpad to enable a user to receive or send messages. Optionally, the screen also serves as the input device, and is a touch screen. Examples include but are not limited to: telephones such as smart phones, desktop computers, laptops, tablets, pads, vehicle systems, smart appliances, and the like.

Internet. A collection of interconnected (public and/or private) networks that are linked together by a set of standard protocols (such as TCP/IP and HTTP) to form a global, distributed network and which are connected by fixed-line or wireless network devices. (While this term is intended to refer to what is now commonly known as the Internet, it is also intended to encompass variations that may be made in the future, including changes and additions to existing standard protocols.)

Identifier. A distinctive text identifier such as a name, logotype (“logo”), trademark, service mark, or other unique identifying information in a respective field of a message service structure.

MSS. A message or messaging service structure such as SMS or MMS, or any communication protocol that is designed to facilitate transmission of any type of message or media content.

SMS. Short Message Service using standardized communications protocols related to a text messaging component of hand-held devices, computers, and mobile communication systems to permit devices to exchange limited text messages.

MMS. Multimedia Message Service using standardized communications protocols related to a text messaging component of hand-held devices, computers, and mobile communication systems that extend SMS to include multimedia content.

Load balancing. Methods of distributing connection requests to servers, such as Round Robin, Dynamic Ratio, Weighted Least, and others. Round Robin, for instance, may be appropriate where servers have approximately equal processing speed and memory; therefore, a connection request is passed to the next server in line such that connections are distributed evenly across the server array being load balanced. In contrast, a Weighted Least connection method may work better with servers that differ significantly in processing speed and memory and can also take into account active connections.

Web Server. A device for transmitting data over the Internet (or preventing transmission), which encompasses hardware/software components that serve information content over a network and hardware/software components that interact with a server component to perform services for users. Any suitable web servers can be used to practice the various aspects of the disclosed invention, such as, for example, the non-limiting and exemplary 5th Dimension servers disclosed herein.

Web Site. A computer system that serves informational content over a network using the standard protocols of the World Wide Web. Typically, a Web site corresponds to a particular Internet domain name and includes the content associated with a particular individual, business, or organization.

TCP/IP. TCP (Transmission Control Protocol) is a set of rules or a protocol used with Internet Protocol (IP) to send data between computers over the Internet. IP handles delivery of the data and TCP tracks individual units of data or packets into which a message is divided for efficient routing.

Web socket. A TCP-based protocol that permits increased interaction between a communications device such as a browser and a web site and provides a way for a server to send content to the browser without solicitation by a client. A web socket permits messages to be passed back and forth while keeping a connection open such that a two-way (bi-directional) ongoing conversation can occur.

Network Application Server. The hardware and software components of a server that manages information over network connections such as internet networks, cellular networks, and the like over which users exchange information.

5th Dimension Mobile Application. A client interface application employed by communications devices such as smart phones, tablets, laptop computers, desktop computers, and the like to send, receive, and resolve standard text messages and to resolve MDN messages. The 5th Dimension Mobile Application represents a non-limiting example of an aspect of the disclosed invention. Any suitable application other than the exemplified 5th Dimension Mobile Application also could be used. For example, aspects of the TextUALL application, described in the inventor's U.S. Provisional Application No. 62/044,182, is another suitable example.

5th Dimension Core™ application. A shared client interface application that can be resident on a server to send and receive standard text messages and to handle MDN messages. The 5th Dimension Core™ application represents a non-limiting example of an aspect of the disclosed invention. Any suitable application other than the exemplified 5th Dimension Core™ application also could be used. For example, aspects of the TextUALL application, described in the inventor's U.S. Provisional Application No. 62/044,182, is another suitable example.

5th Dimension Mobile Domain Name™ (MDN™) application. A unique text name, identifier, distinct text identifier, distinct message identifier, distinct sender identifier, address, “friendly name”, “text tag”, “text caller ID”, and related applications and servers. An MDN application converts a text address such as, but not limited to, a numeric/character sequence into a unique text identifier. An MDN server manages messages containing MDN names. The MDN™ application represents a non-limiting example of an aspect of the disclosed invention. Any suitable application other than the exemplified 5th Dimension MDN™ application also could be used. For example, TextURL, described in the inventor's U.S. Provisional Application No. 62/044,182, is another suitable example.

Decompile/disassemble (compile/assemble). Generally, decompile means to translate computer readable program code (object code) into a higher level of abstraction such as human readable source code (decompiled source code usually does not contain every detail of original source code). Disassembly, too, generally refers to the translation of executable machine code into human readable text; however, disassembly does not generate the more concise, higher level text that results from decompiling. To map the content of a communications device including contact information and field data, translation of code by decompiling or disassembly may be involved.

The foregoing definitions are not intended to limit the scope of the present invention, but rather are intended to clarify terms that are well understood by persons having ordinary skill in the art. It should be appreciated that the defined terms may also have other meanings to such persons having ordinary skill in the art. These and other terms are used in the detailed description below.

Detailed reference will now be made to the drawings in which examples embodying the present subject matter are shown. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed descriptions are provided by way of explanation only and are not meant as limitations of the disclosure. The present subject matter thus includes any modifications and variations of the following examples as come within the scope of the appended claims and their equivalents. The detailed description uses numerical and letter designations to refer to features of the drawings.

The disclosure includes in general engagement platforms that have single unified mobile app screens. An App according to the disclosure can be a default messaging app on an Android® platform. The engagement platforms bring together an engagement environment comprised of SMS, MMS, branded identities, privacy, and rich interactive content including but not limited to one or more of the following:
surveys, trivia, questionnaires, polling, user input, decision trees, scheduled reminders, grouping, and sub conversations.
audio messaging; for example, audio messages of three 3 minutes or less to replace or substitute for conventional voicemail
picture messaging; for example, video messaging having video messages of 3 minutes or less, and interactive video (e.g., draw on video, find and circle Waldo and circle, and/or write comments on particular frames or segments of video.
barcodes such as QR codes, Code 39, UPC-A, and PDF417.
commerce such as credit applications, shopping cart checkout, delivery tracking
location based engagements such as fencing, proximity, zip code
privacy—websocket uses SSL encryption, PIN number to get into conversation, all messages are encrypted, NoTrace™
screen sharing—customer/tech support
file sharing
streaming audio such as walkie talkie, telephone calls
streaming video such as remote diagnosis, video calls, and object finder.

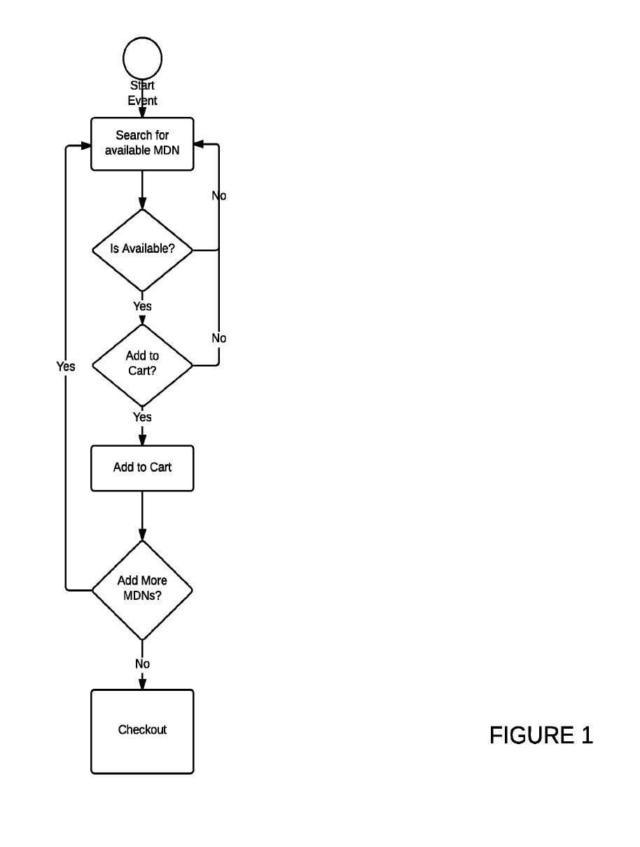

Turning now to FIG. 1, a subscriber such as a business or an individual may search for a unique text name, tag, or identifier herein referred to as an MDN through a subscription service such as provided at www.5thdm.com. If a desired MDN is available, the subscriber may purchase that identifier. As further shown in FIG. 1, the subscriber may purchase multiple MDNs and check-out after completion of the purchases.

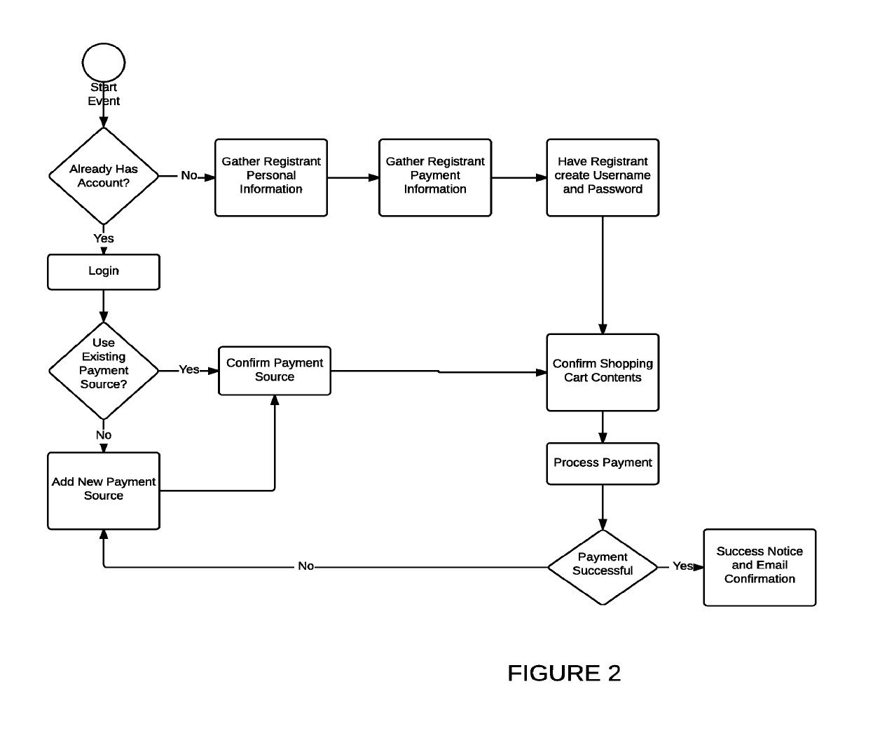

FIG. 2 shows a check-out process related to FIG. 1. Here, the exemplary check-out process includes gathering information from the subscriber and assigning registrant status to the subscriber based on solicited information.

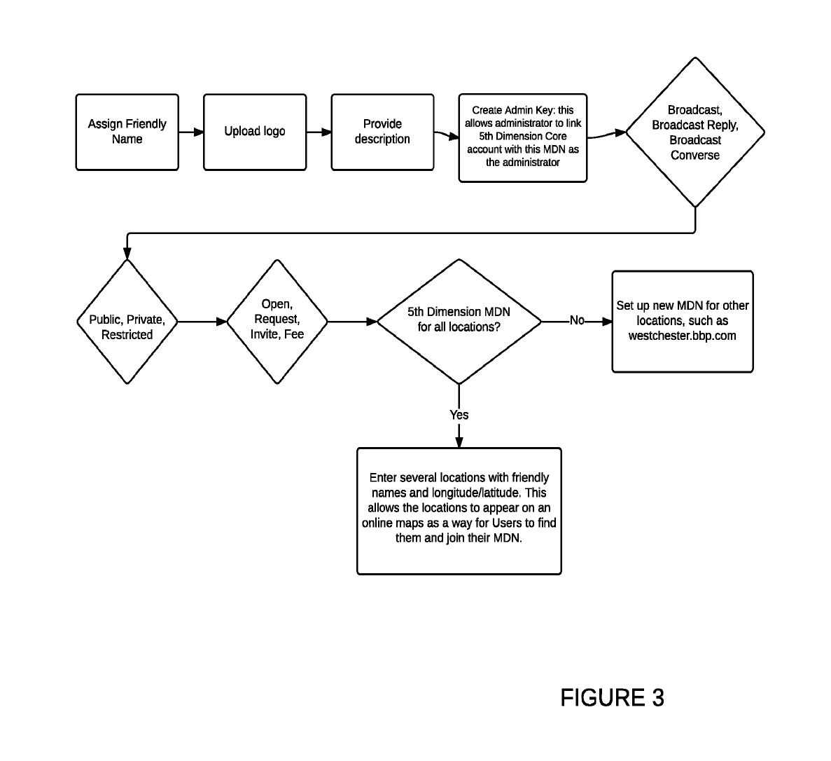

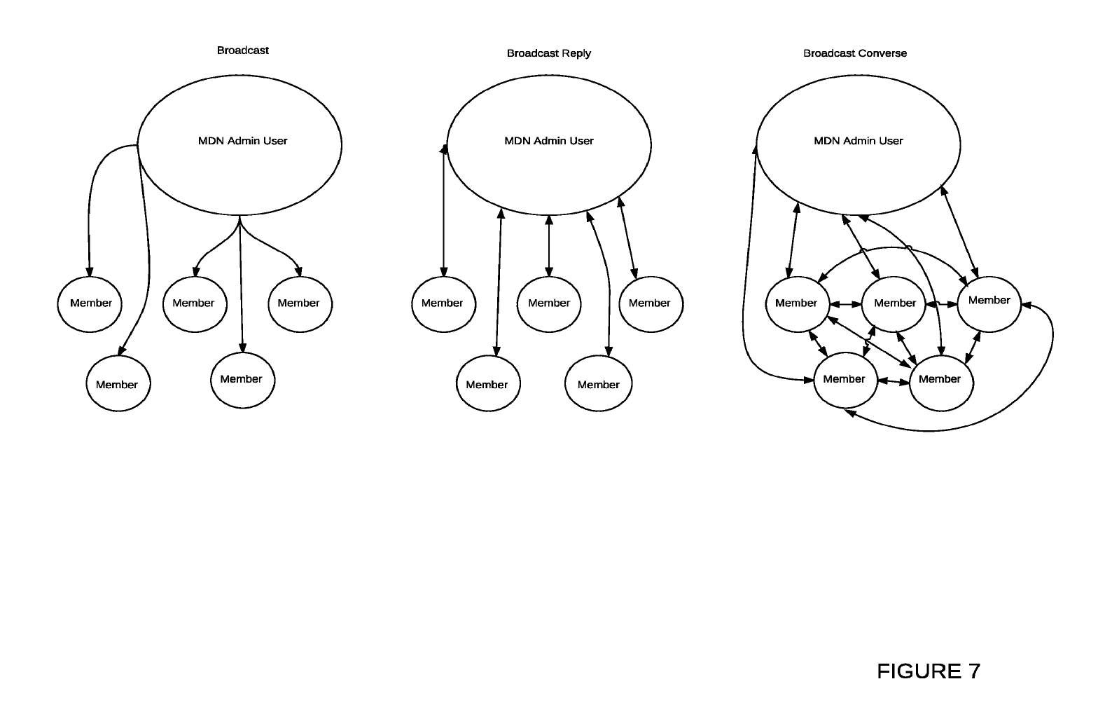

Turning to FIG. 3, a registrant, such as a business or company, will configure its unique text identifier. As shown in this example, the company and its assigned “friendly name” is “Bob's Burgers and Pizza” (“BBP”). BBP purchased its MDN “bbp.com” in accordance with the process shown in FIGS. 1 and 2. An owner or IT administrator for BBP uploads the company logo or stylized mark and provides a description if desired. Here, for example, the description is: “Your BEST local burger and pizza shop!” The administrator creates a unique administrative key and chooses a communication structure, which in this case is “Broadcast Reply”. Exemplary communication structures are explained in more detail in FIG. 7 below. The administrator selects the types of communication and membership, Public and Open, respectively, in this example. Also, if desired, the administrator can provide location details such as a physical address, latitude and longitude, multiple locations for chain businesses, etcetera. The administrator may also choose how many messages the company would like to send each month or other periodic basis. Finally, in this example, the administrator can require certain types of information from end-user subscribers such as name, telephone number, electronic mail (e-mail) address and the like.

Also with respect to FIG. 3, the MDN administrator is able to upload a logo or brand image that will be the image/logo that will be displayed when users decide to join a particular MDN. When the MDN administrator creates engagements and sends them to members, the uploaded logo will appear on the members' screens identifying the MDN from which the engagement came.

This is analogous to a brand or image that organizations or individuals would use on their respective websites or signage outside of their retail locations.

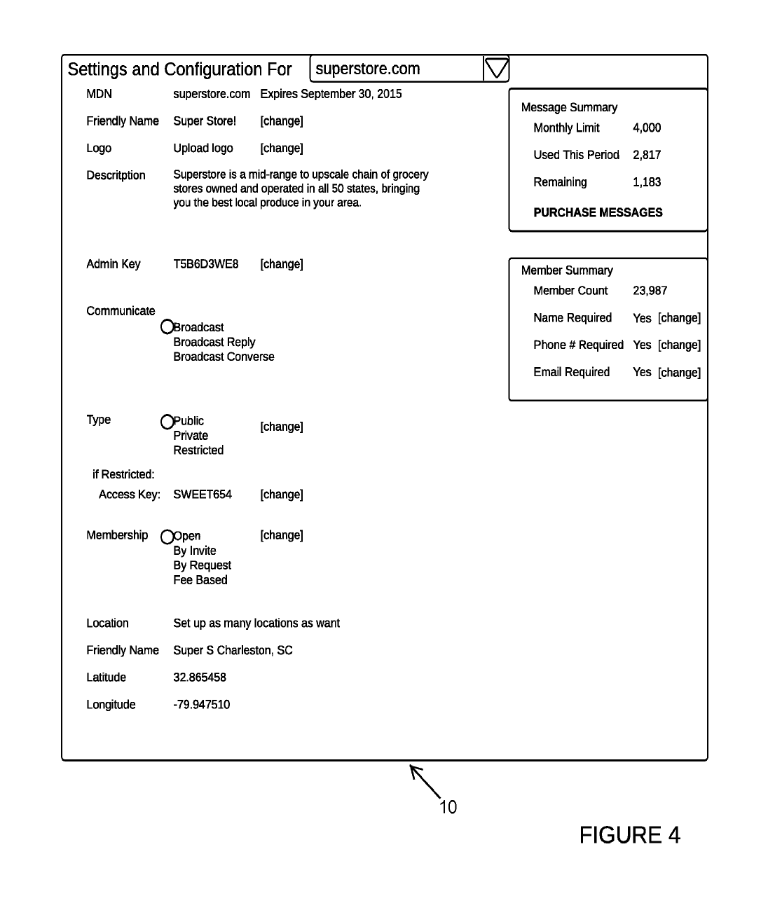

Turning to FIG. 4, in order to accomplish the actions introduced in FIG. 3, the owner or administrator should be able to access an account configuration screen 10 via a computer, kiosk, smart phone or the like. As noted above, the account configuration may be handled or administered by an individual within the business such as the IT administrator. As FIG. 4 shows, the MDN configuration can include a “Friendly Name” (such as a trade name of the business or a “DBA” (“doing business as”) name) (here, “Super Store!”). The administrator may also upload a graphic or non-alphanumeric image such as a company logo or stylized mark, which as explained by exemplary operation herein below, the system will map and apply to an appropriate text message address field such that an end-user device will display the logo on the device.

FIG. 4 further shows that the registrant administrator can select whether a specific text message is public, private or restricted with respect to replies and to what audience or group of recipients the message is directed, such as “open”, “by invitation”, “by request” or “fee based”. Still further, the registrant administrator can restrict the message to a particular location, such as one store or group of stores in a particular state, for instance. These selections will be described in further detail with respect to exemplary operations below.

The purpose of the Admin Key: In its current state MDN administrators can only use the website to create and engage with MDN members. Even though the MDN administrators have the 5th Dimension App installed on their mobile devices they are simply members, and therefore are only able to engage as members; they do not have the ability to create some of the most engaging content that MDN administrators are able to do using the website dashboard. The purpose of assigning the Admin Key on the MDN details dashboard is to allow the administrators the ability to identify themselves as the MDN Admin using their mobile devices, and therefore allow them to create engagements using their mobile device as they would if they were using the website dashboard.

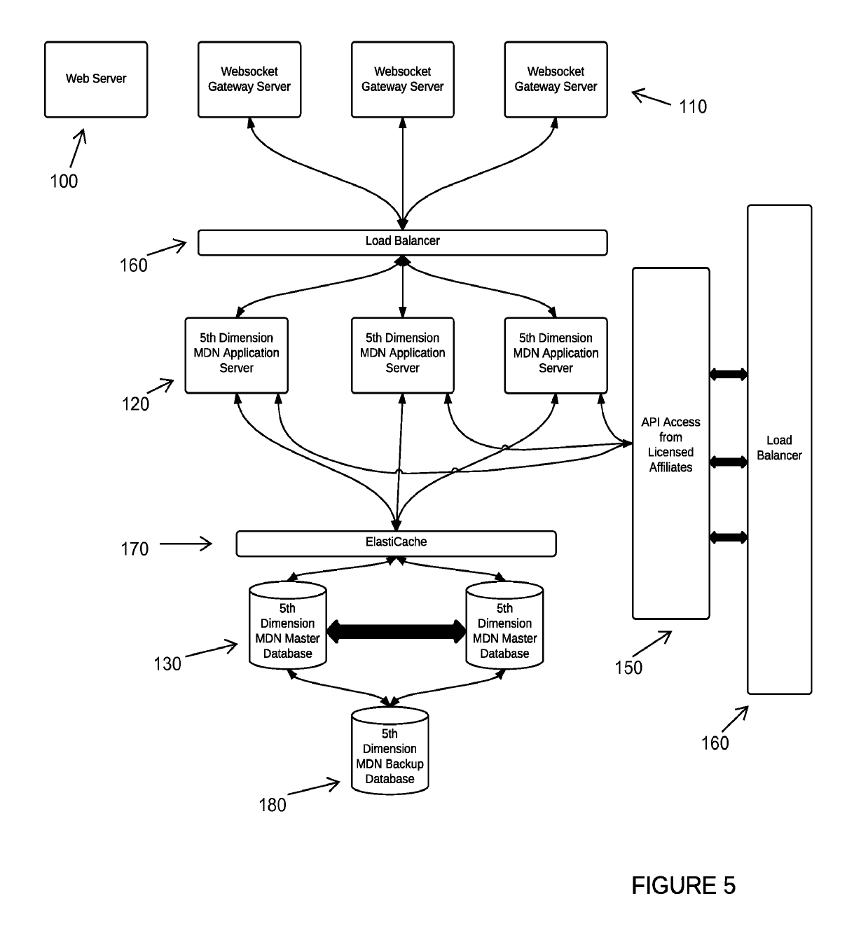

Turning now to FIG. 5, an MDN server perspective is shown. Broadly, the system may include at least one web server 100, at least one web socket gateway server or other form of gateway server 110, at least one MDN application server 120, at least one MDN database 130 and an API 150 for a licensed affiliate. The system may include load balancers 160 and elastic caches 170 to handle multiple or redundant servers to ensure efficient data flow. Likewise, multiple databases and back-up databases 180 may be provided to accommodate multiple servers and larger and more robust systems depending upon subscriber and user volume.

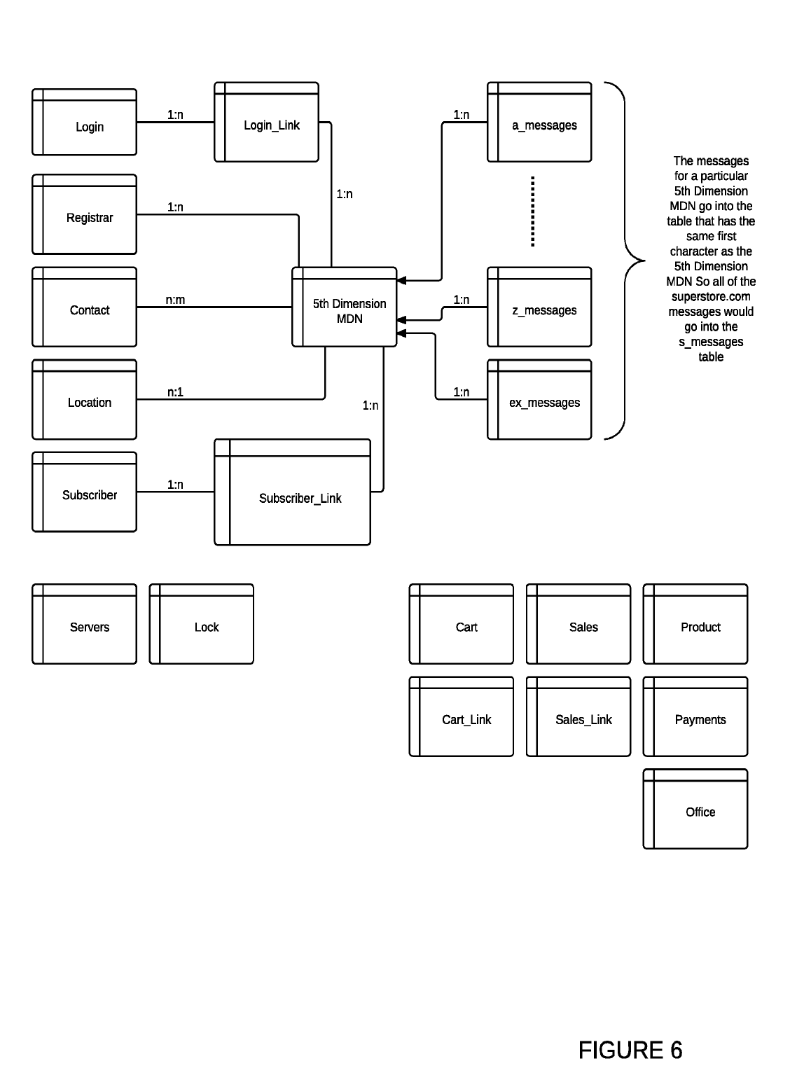

FIG. 6 shows the interaction between contacts or end-users, registrants (registrar) and databases. Here, text messages (engagements) for a particular MDN are applied to a table in which the table has the same first character as the MDN. The software and protocol related to end-user purchases from the sending company are also shown in FIG. 6 and explained by exemplary operation below.

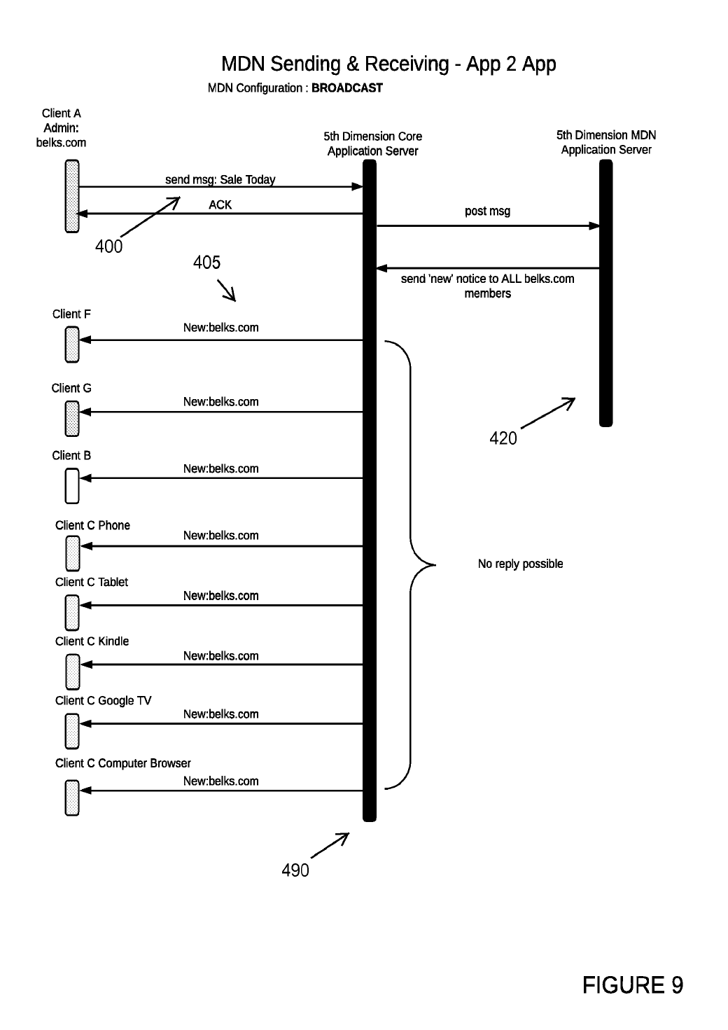

As briefly introduced above, FIG. 7 shows various types of MDN communications. In this example, three types may be provided: broadcast, broadcast reply, and broadcast converse. In broadcast, the administrator sends messages (engagements) to all members or end-users, or only to specific members according to the selection screen described above in FIG. 4. The selected members, for example, will receive the messages but will be unable to reply or otherwise respond to incoming messages, as will be further described with respect to FIG. 9 below.

With further reference to FIG. 7, in broadcast reply mode the MDN owner or administrator sends messages (engagements) to all users, or only to select members. Here, the recipients are able to reply to the administrator or owner. Specifically, the owner and the recipient(s) can engage in private conversations regardless of whether the original post was broadcast to all members or only to the recipient.

FIG. 7 also shows a broadcast converse mode in which the owner or administrator sends messages (engagements) to any or all members or users. In this example, the recipients are able to reply to a message and any and all posts from the owner are public to all members as well as any and all replies that follow. In this mode, the members have the opportunity to opt out of seeing any messages sent in response by or from other members or users

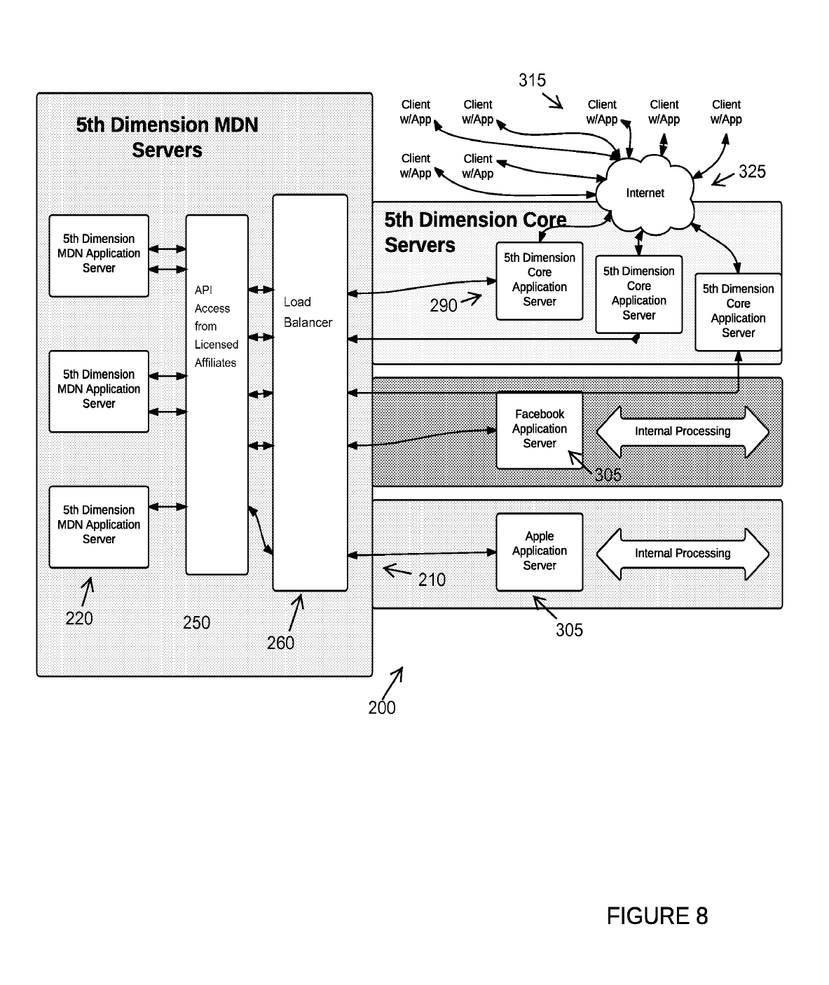

With reference now to FIG. 8, an application-to-application server overview 200 is provided. In this example, multiple MDN application servers 220 are in communication with a load balancing connection 260 utilizing, for instance, a web socket connection 210 and a Round Robin load balancing protocol. The disclosure is not limited to these examples; other types of connections, such as Google® Cloud™ Messaging, Apple® Push Notifications (APN), and other load balancing protocols designed for specific server arrangements may be utilized.

FIG. 8 further shows an application-programming interface (API) 250 abstractly interposed between a software application and servers. Here, communications flow between the API 250 and a plurality of 5th Dimension Core servers 290 as well as other application servers such as those of Facebook® and Apple® 305. As shown in this example, clients with applications or users on stand-alone or independent systems 305 such as Facebook® and Apple® that are subscribed to MDN™ may communicate among each other without having to access external communication carrier networks, as will be explained in greater detail below.

With continued reference to FIG. 8 the 5th Dimension Core application servers 290 are in communication with a plurality of end-users or devices 315 via the Internet 325. The devices 315, as shown, may communicate with each other and with 5th Dimension Core servers 290 and/or with the MDN application servers 220 depending upon the type of message being handled as noted with respect to FIG. 7.

Turning now to FIG. 9, a message 400 is handled according to an MDN configuration selected by the owner, Client A, according to the settings described with respect to FIG. 4. In this example, the owner or its administrator has selected the Broadcast option described above in FIG. 7. As FIG. 9 further shows in this example, the administrator sends the sales message 400 under the Broadcast option, which arrives at one of the 5th Dimension Core servers 490. The 5th Dimension Core servers 490 determine that the message 400 contains an MDN component and sends it to the MDN application servers 420 for processing. In this example, all MDN members, clients or subscribers having a 5th Dimension Core application on their devices receive a notice 405 of the sales message 400. Because the message is a Broadcast tag, no reply by the clients is possible. Alternatively, as detailed herein, the members might not have a 5th Dimension Core application on their devices, and services to which they are subscribed may act as the translator and send the message to the subscribers. Still further, members having “dumb phones” may rely on the phone manufacturers; for instance, a phone may be programmed by its manufacturer to recognize an MDN component and translate the message identifier into a friendly name where the manufacturer is itself an MDN client.

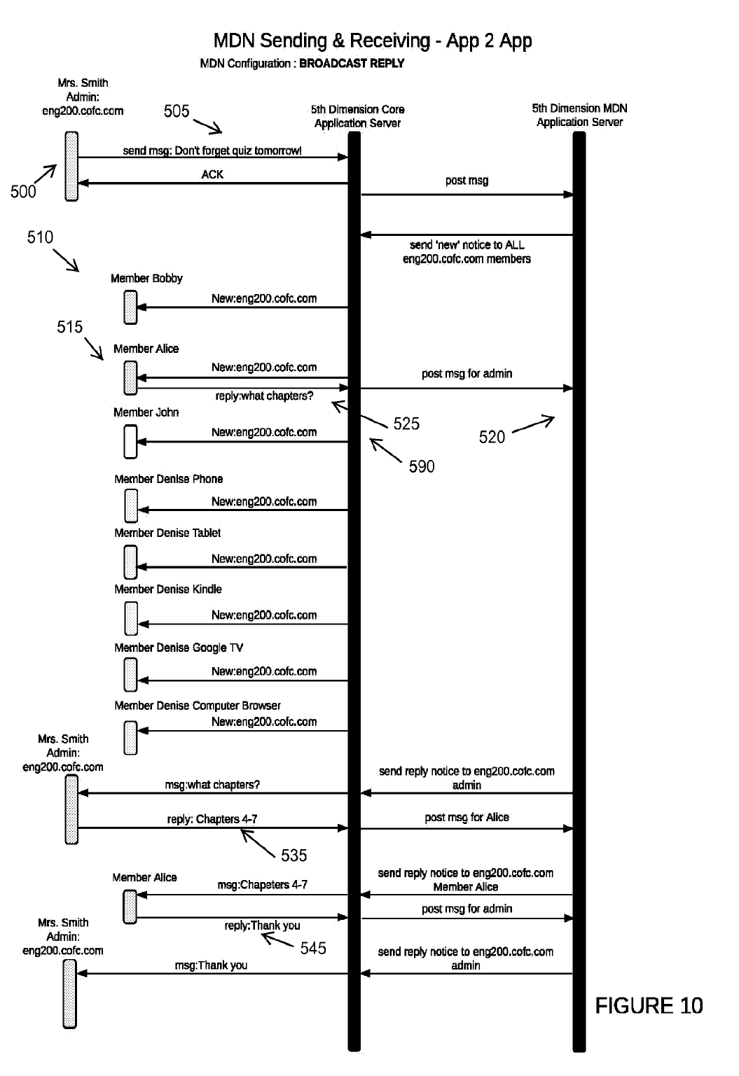

FIG. 10 is similar to FIG. 9, but in this case, in a first example, a message administrator, such as teacher Mrs. Smith 500, has selected the Broadcast Reply option described in FIG. 7. Mrs. Smith sends her first message 505 regarding a quiz as Broadcast Reply to a group of students 510, all of whom are subscribers having 5th Dimension Mobile Application on their communications devices. As above, the quiz message 505 is recognized by the 5th Dimension Core servers 590 as containing an MDN component and therefore, the quiz message 505 is sent to the MDN application servers 520 for processing and posting to the devices of the students 510.

In the example of FIG. 10, because Mrs. Smith 500 selected the Broadcast Reply option, one student Alice 515 can reply with a question: “What chapters?” 525 As above, the 5th Dimension Core servers 590 recognize the MDN component and send the question 525 to the MDN application servers 520 for processing and delivery to Mrs. Smith 500. The exemplary sequence may continue with a reply 535 from Mrs. Smith 500 and a final reply 545 from Alice 515.

As introduced in FIG. 8 above, because Mrs. Smith 500 and Alice 515 have the 5th Dimension Mobile Application on their respective communications devices, FIG. 10 further shows that they may communicate with each other by way of the 5th Dimension Core application server 590 without having to access external communication carrier networks. More specifically, the 5th Dimension Core application server 590 recognizes that the communications between Mrs. Smith 500 and Alice 515 are 5th Dimension Core application-related communications and processes those communications within the 5th Dimension Core network.

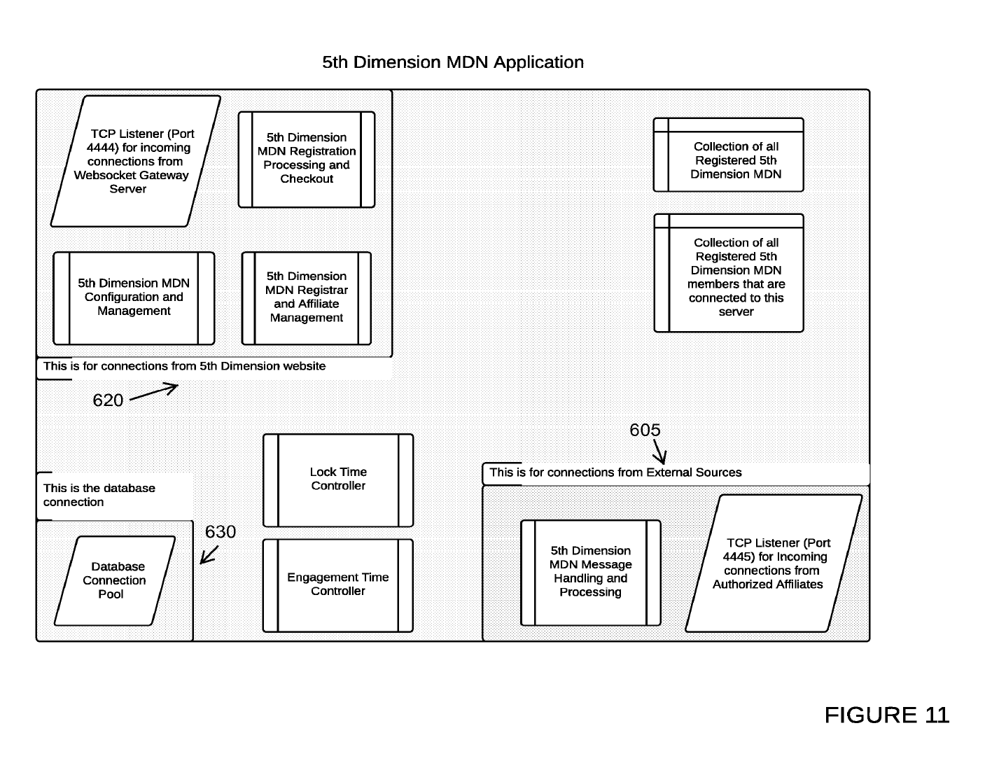

FIG. 11 shows MDN application connections. More specifically, an MDN application is in communication with the 5th Dimension website 620 as shown in FIG. 8; with the database 630 as in FIG. 6; and with external sources 605. As shown, these communication connections include listening for incoming connections from a web socket, for registration and configuration of accounts, and for engagement handling.

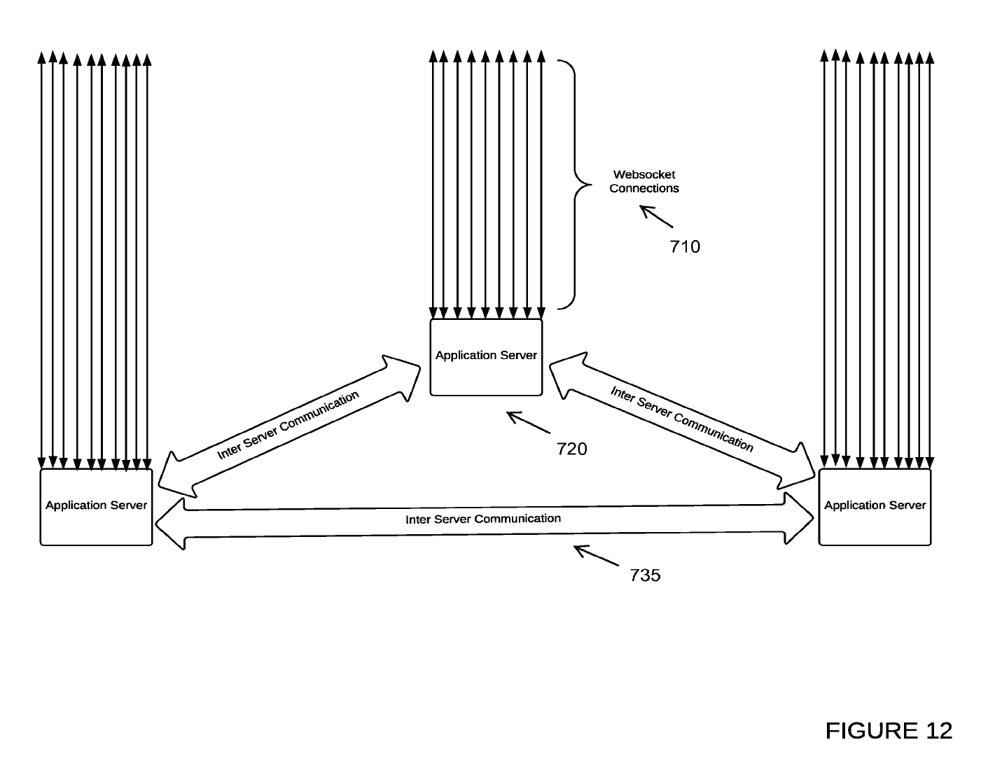

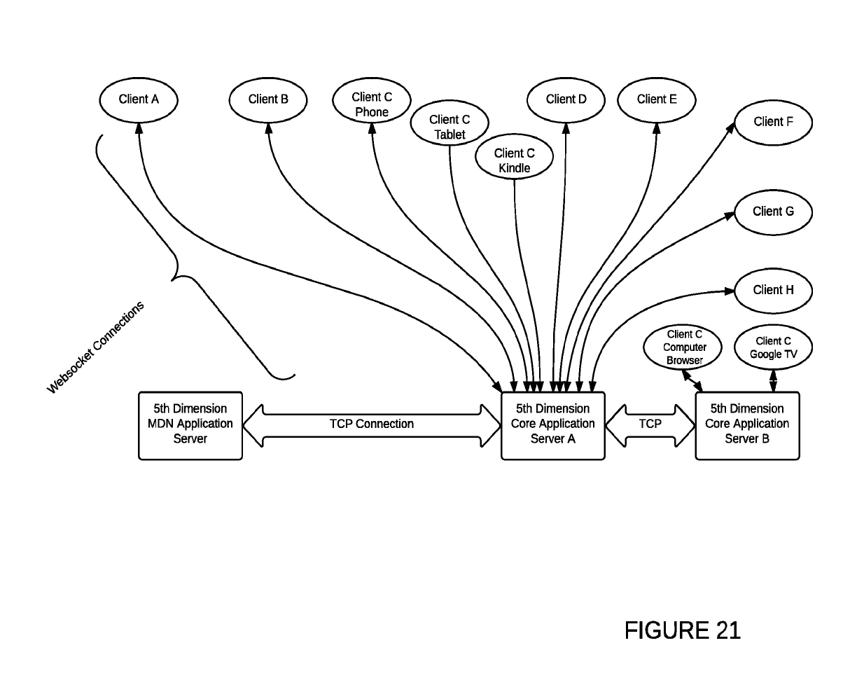

FIG. 12 is a detailed view of the connections from web sockets 710 to application servers 720 and their interserver communications 735, as briefly introduced in FIG. 21. Although not shown in FIG. 8, this is one possible configuration wherein messages and engagements can be effectively delivered between and amongst 5th Dimension MDN application servers and 5th Dimension Core application servers. Additionally, the communications protocol of the application servers 720 monitor for any new servers added to the system in order to most efficiently load balance. Further, the protocols listen for connections from other machines or systems in order to set-up additional web sockets 710 if necessary. Also, the application servers 720 are connected to each other to monitor 5th Dimension Core messages. In other words, for example, if two users each having 5th Dimension Mobile Applications installed on their respective devices, the interserver communications 735 allow the user messages to be sent between the servers 720 internally rather than externally to a carrier or outside server, thereby reducing user data usage. Moreover, the user does not require an active smart phone to communicate internally with another 5th Dimension Core user—a wireless area network connection such as Wi-Fi™ technology will suffice to connect one 5th Dimension Core user to another via the 5th Dimension Core application server 720. Stated another way, the user does not require a phone at all; all that is needed in accordance with the present disclosure is network connectivity, which may be done on any communications device such as a tablet in order to receive a text, monitor a text, etcetera.

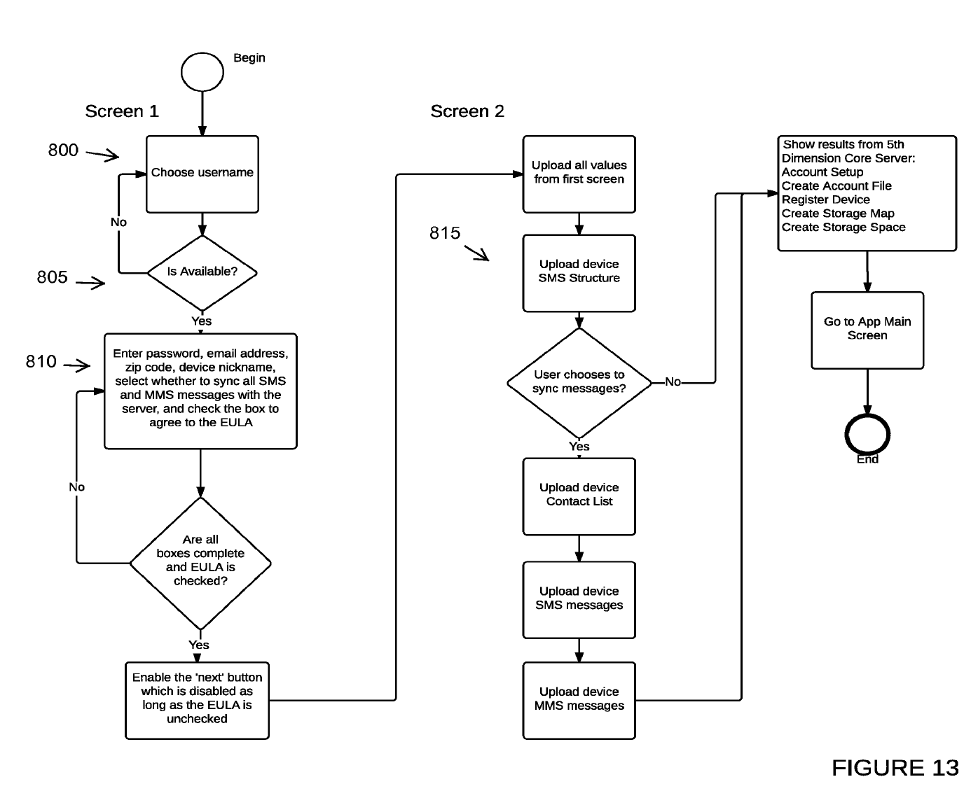

With reference to FIG. 13, an exemplary process is shown for creating a 5th Dimension Core account after downloading the 5th Dimension Mobile Application to an end-user device such as a smartphone. As shown, an end-user or client chooses a username 800. If the username is available 805, the user submits contact information such as an electronic mail address and is asked to read and agree to an end-user license agreement (EULA) 810 before proceeding. As FIG. 13 further shows, the message structures are interpreted, and if necessary, decompiled or disassembled then uploaded 815 to a 5th Dimension Core application server. The system will also recognize if the user brings another device on-line that is associated with the user 5th Dimension Core account.

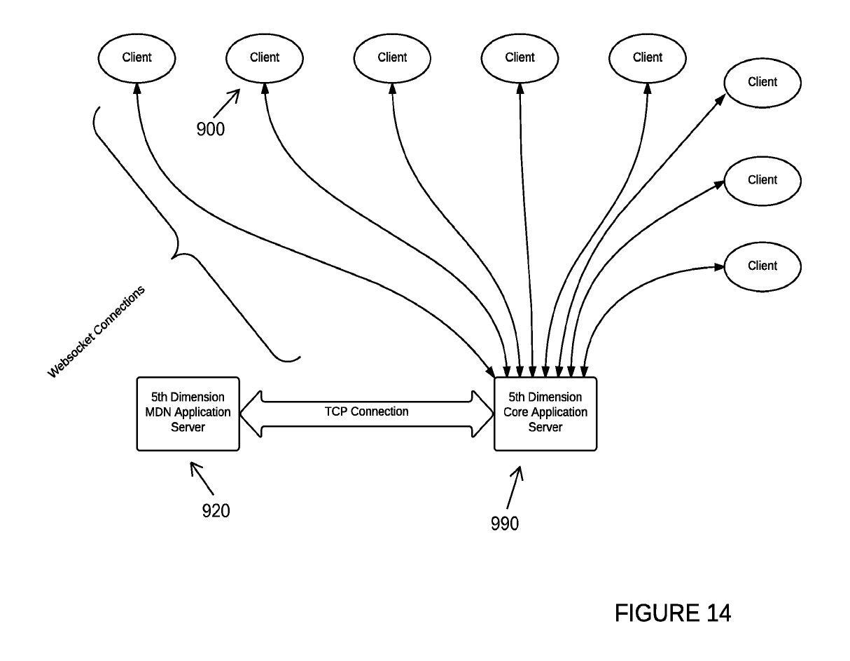

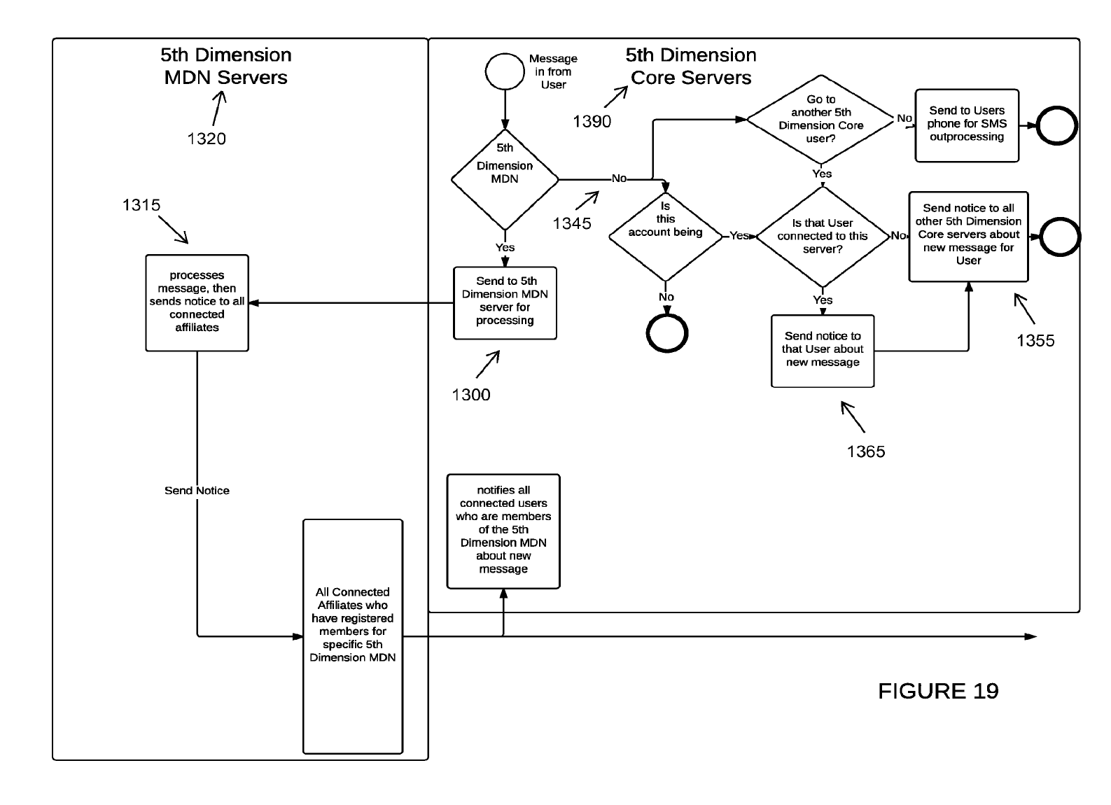

FIG. 14 is an overview of the 5th Dimension Core client-to-server communications. In this example, text messages originate with a client 900 and are sent to the 5th Dimension Core servers 990 as in FIG. 19. The 5th Dimension Core server 990 identifies whether the message is part of an MDN conversation. If the message is associated with an MDN conversation, the message is routed to the MDN application server 920 for processing. Otherwise, the message is processed by 5th Dimension Core application server 990 as in FIG. 19.

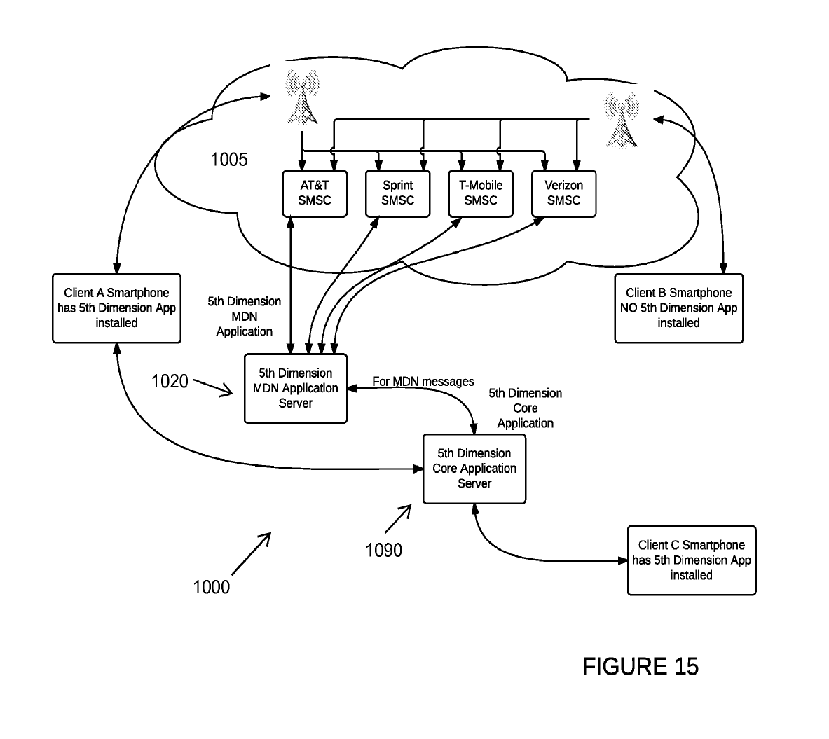

Turning to FIG. 15, an exemplary overview 1000 of a workflow for application-to-application and application-to-no application is shown. For instance, client A has a 5th Dimension Mobile Application installed and can communicate via a 5th Dimension Core application server 1090 with another client C also having a 5th Dimension Mobile Application installed in a scenario in which messages are sent internally without going through a wireless provider 1005. This scenario is described further below with respect to FIG. 21 below.

FIG. 15 also shows messages being routed from client A to client C via the MDN Application Server 1020 and a wireless carrier 1005. This scenario is also described in more detail below with respect to FIG. 21.

Finally, FIG. 15 shows routing of messages from client A or client C via the MDN Application Server 1020 and 5th Dimension Core Application Server 1090 and/or directly through a wireless carrier 1005.

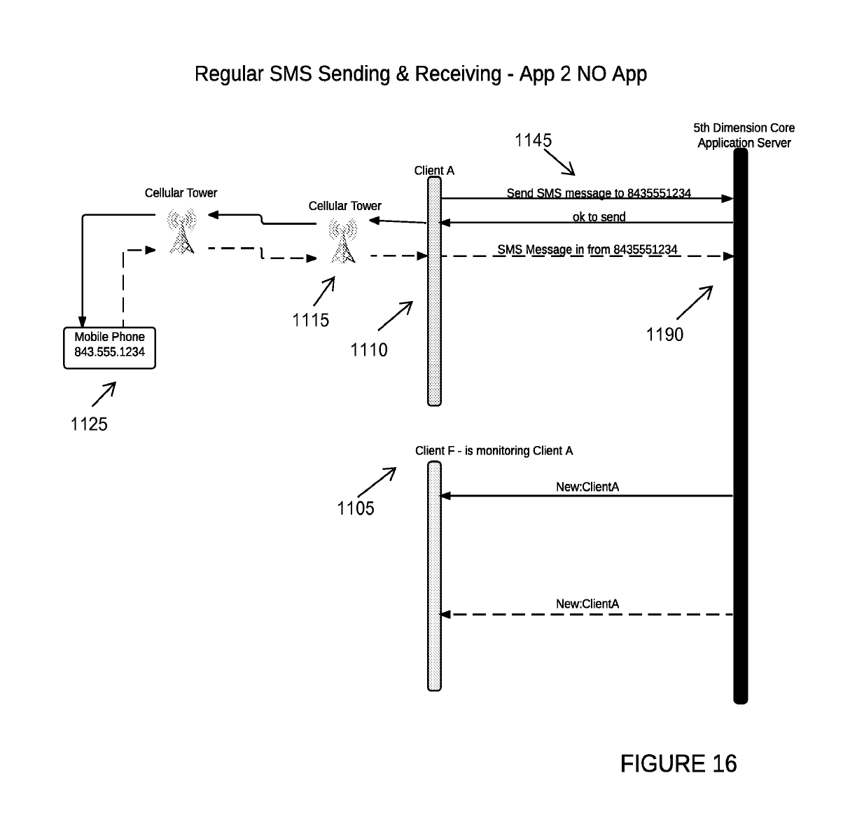

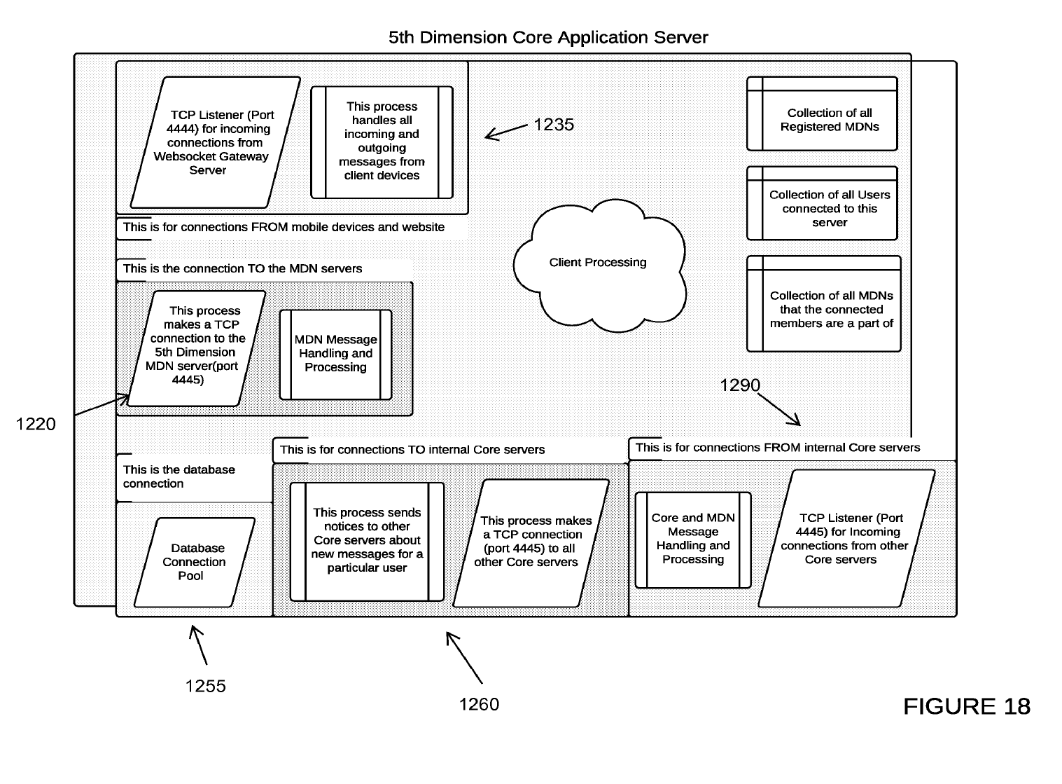

FIG. 16 is a diagram showing a standard SMS message 1145 being sent by an end-user device having a 5th Dimension Mobile Application 1110 to another device 1125 without a 5th Dimension Mobile Application. The SMS message is processed by the 5th Dimension Core application 1190 and sent to a wireless service provider via a carrier, i.e., a cellular tower 1115 in this example. As shown in solid lines, Client A sends an SMS message to a mobile phone 1125 that does not have a 5th Dimension Mobile application. The message is received and recognized by the 5th Dimension Core server 1190 according to the protocol in FIG. 18, below. The 5th Dimension Core server protocol processes the SMS message 1145 and sends it via Client A's mobile device to the cellular tower 1115 to the mobile phone 1125. Notably, the message 1145 is also sent in real-time to Client F, which is monitoring the message traffic of Client A. Finally, FIG. 16 also shows in dashed lines that any message or reply from the mobile phone 1125 to Client A is sent and received simultaneously in real-time on the device of Client F. This arrangement is useful, for instance, for a parent to monitor a child device or for an employer to monitor employee messages to reduce liability or for compensation purposes. In this embodiment, the device of Client F does not require downloading a separate monitoring application, nor does Client F have to open a communications account to see the messages to and from Client A after the fact.

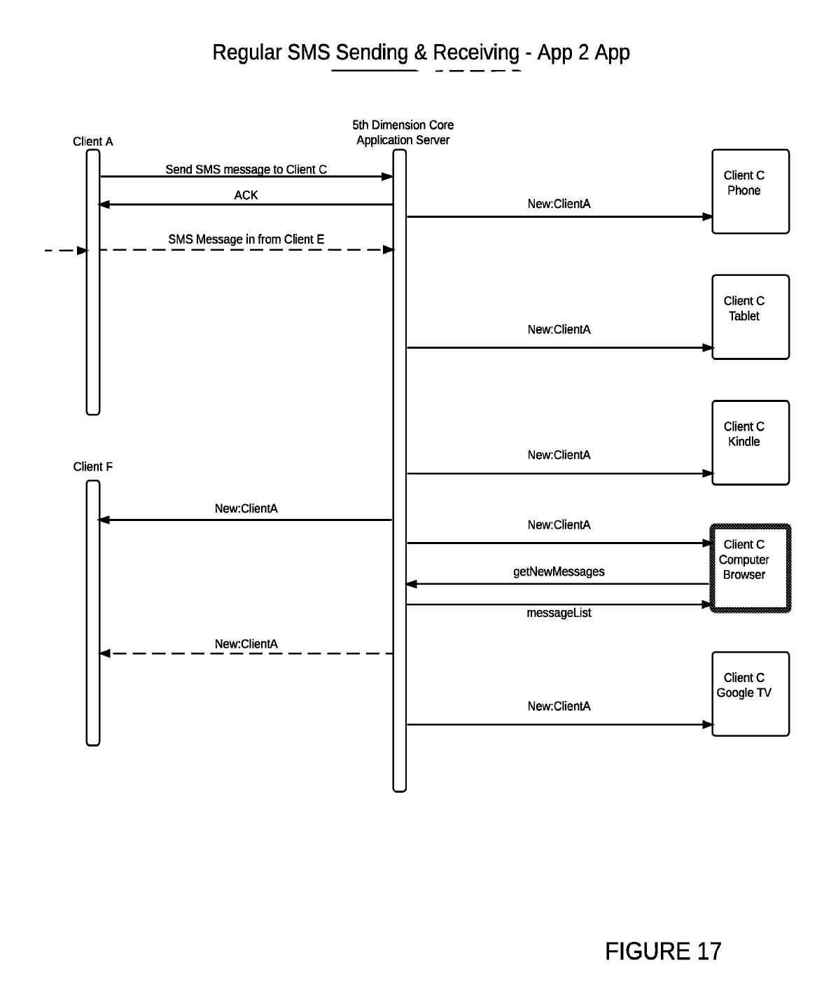

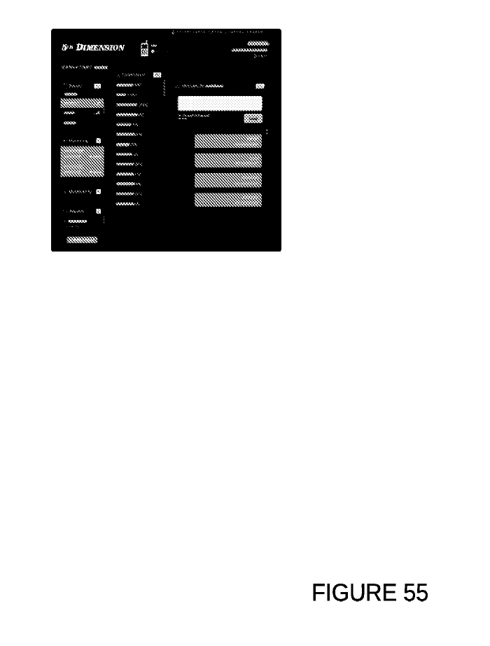

FIG. 17 is a diagram similar to FIG. 16 except that both the sender Client A and a receiver Client C have the 5th Dimension Mobile Application installed and both are sending or receiving standard SMS or MMS messages. As in FIG. 16, Client F may monitor the messages of Client A in real-time, which also will be transparent to Client A. FIG. 17 further shows that with the 5th Dimension Mobile application installed, Client C may receive the messages on any communications device such as a smart phone, a tablet, a Kindle® product, or Google® television. If Client C has access to a computer, Client C can obtain text messages via the 5th Dimension Core web browser interface, as in FIG. 55, on the computer.

Finally, FIG. 17 shows that Client C's and Client F's devices may receive the notice and respond in one of two ways, depending on whether a device happens to have the conversation with Client A as the current activity on the screen. If the conversation with Client A is the current activity, then the client application (either the 5th Dimension Mobile application or the 5th Dimension Core web browser interface) makes a separate request back to the application server for the message, which will be immediately returned to the device/browser and displayed on the screen.

Turning now to FIG. 18, exemplary processes and protocols of a 5th Dimension Core application server 1290 are shown. Here, connections from devices having 5th Dimension Mobile applications, and processes and connections to the 5th Dimension MDN server 1220 as in FIG. 8 are shown. Further, database connections and connections to and from internal 5th Dimension Core servers 1290 are shown. More specifically, each of the processes 1235 may represent one or more executable programs modules that are stored and executed within the 5th Dimension Core server 1290 or the 5th Dimension MDN server 1220. Alternatively, the processes 1260 may be implemented in a plurality of program modules remotely connected to respective servers and to each other. Data for any of the applications contained within or associated with messaging applications used by a client device may be provided by a database connection pool 1255 that is coupled to 5th Dimension MDN server 1220.

FIG. 19 shows a 5th Dimension Core message handling overview. As shown, a message arrives from a user (5th Dimension Mobile application or 5th Dimension web browser interface) and the 5th Dimension Core server 1390 assesses whether it is an MDN message or has an MDN component. If so, the message is sent to the MDN server 1320 for processing. See process at 1300. The MDN server 1320 processes the message and sends a notice to all connected affiliates that have registered members for that specific MDN. See process at 1315. If the message is not an MDN message, the message is processed internally by the 5th Dimension Core server 1390 such that, for instance, a standard SMS message is sent to a user's device via the 5th Dimension Core server 1390 rather than through an external carrier. See process at 1345. As shown, if the user is not connected to the server, notice will be sent to all 5th Dimension Core servers. See process at 1355 and FIG. 17. The processing module 1365 sends notice to a user about a new message or sends the message to a user's phone for SMS processing.

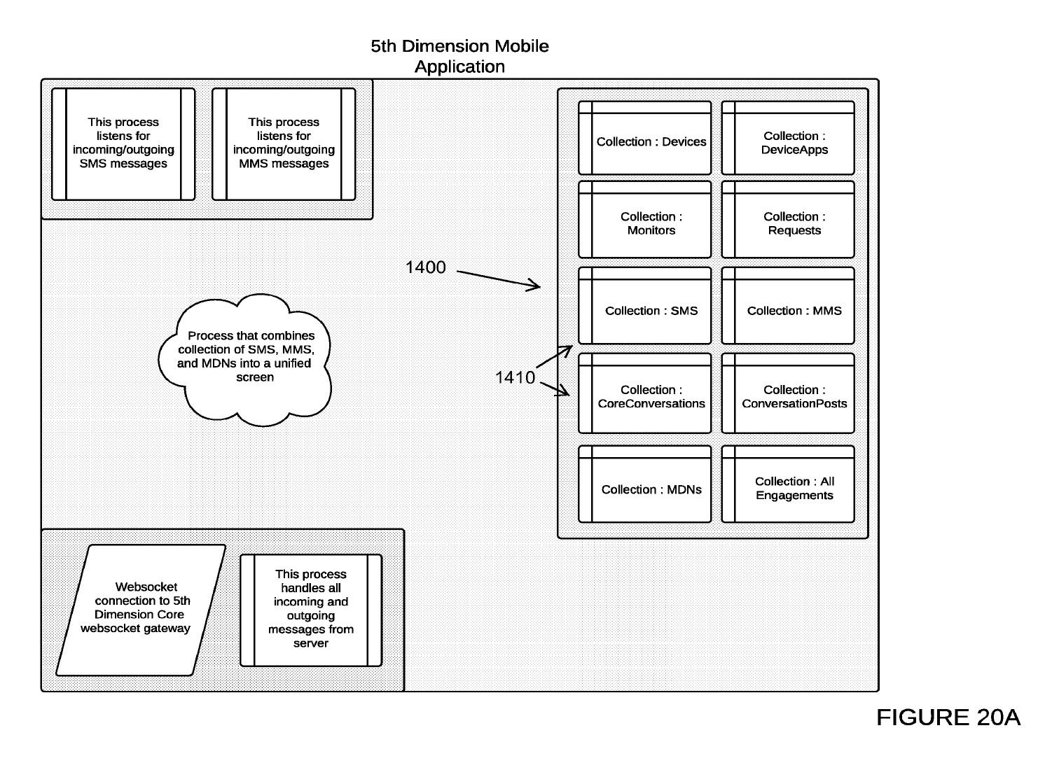

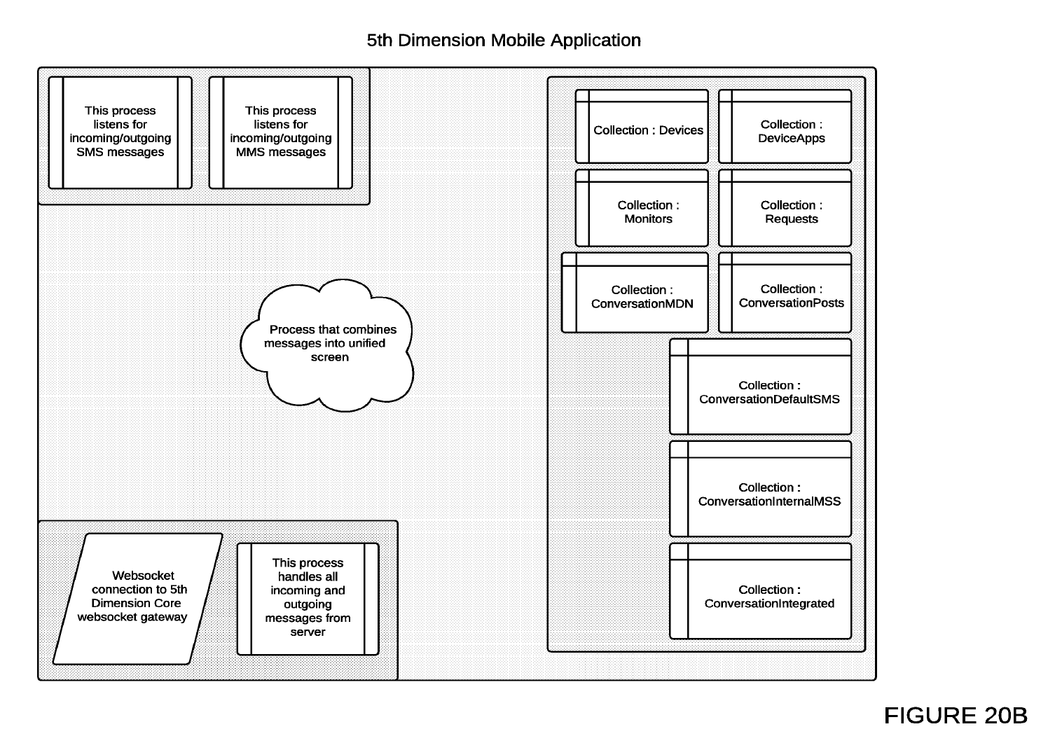

FIGS. 20A and 20B shows a 5th Dimension Core client application in which the process listens for incoming/outgoing SMS and/or MMS messages and processes all incoming and outgoing messages from the server. A plurality of Collections 1400 includes monitoring, conversations, requests, conversations posts, devices, applications and MDNs. As necessary, the protocol will construct message presentation fields for display on an end-user device by collating SMS, MMS, and MDN conversations 1410.

With specific reference to FIG. 20A, the 5th Dimension Mobile application is designed to store each type of communication structure in its own collection. When the 5th Dimension Mobile application loads, a specific background process retrieves the complete list of SMS and MMS messages from their respective device default database tables. These lists are organized by message timestamp in descending order, newest messages listed first. Iterating through the SMS list first, a custom SMS object is created, for each message, and added to a specific, temporary memory only, collection of SMS objects. Next, the same thing happens for MMS messages. This is being done while the separate background service thread contacts the 5th Dimension Core servers and logs in, and upon successful login, the servers return the other sets of collection objects (e.g., devices, deviceApps, monitors, requests), which are then created.

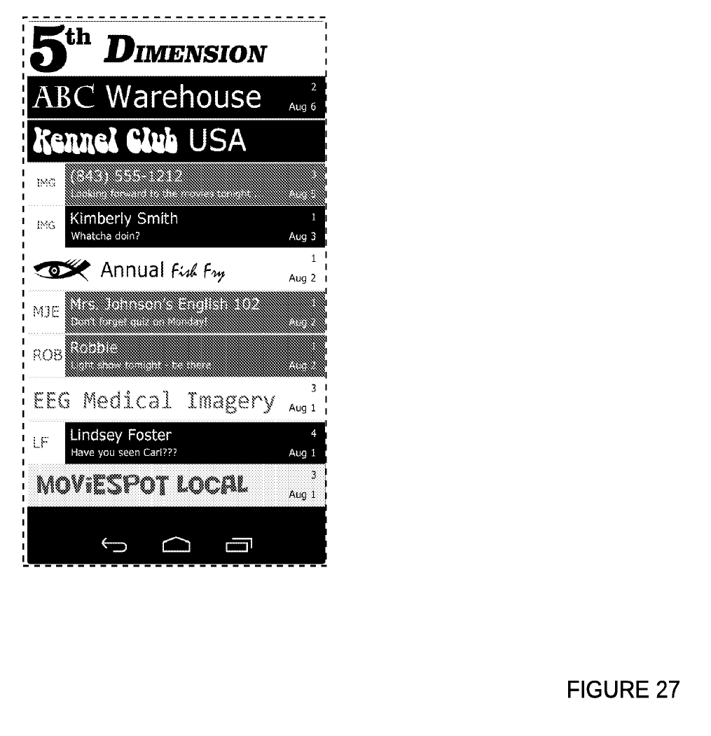

Once the SMS and MMS collections are created, the process then begins to iterate through both collections to create a list of conversations, organized by address and or conversation thread id, and ordered by the most recent message timestamp. This is a separate collection of conversation objects. At the same time, a collection of AllEngagement objects is being created. The collection of AllEngagements is what is used to create, maintain, and update the main conversation screen on the 5th Dimension Mobile application screen, as in FIG. 27.

As the background service receives the aforementioned collections, a separate process then iterates through the MDN collection and using each MDN last engagement timestamp, properly positions the MDN object within the AllEngagements collection.

All of this happens in the background and happens in real time as message/engagements are received/leave the device. If the user happens to be looking at the respective screen then they will see the changes applied as they happen; there is no need to refresh screen or to do anything to update screen to reflect the latest information.

With reference now to FIG. 21, a client-to-server communication message default workflow is shown. Here, a number of clients A-H have accounts with 5th Dimension Core applications. The client messages are sent internally within the 5th Dimension Core application server A. The messages are not sent through the clients' SMS service plan providers. In another scenario, Client A may send a regular SMS text to Client C having a 5th Dimension Core account. Client A is being monitored by Client F. The 5th Dimension Core application server A processes the message internally and recognizes that the destination is another application user. In still another scenario, the application will propagate a notice to all of Client C's and Client F's devices beginning with the processing server A that are connected. Server A recognizes whether all of Client C's and Client F's devices are connected to Server A. If there are less connected, server A will send the same notice to all other devices of Clients C and F in case they are connected to other 5th Dimension Core application servers.

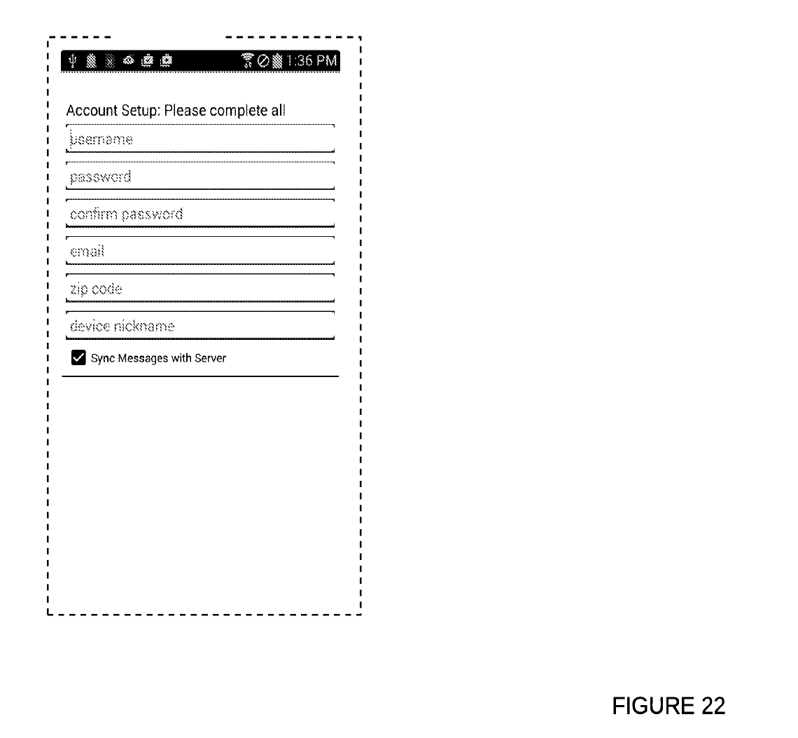

FIG. 22 is an exemplary screenshot of a 5th Dimension Mobile application account setup process as introduced in FIG. 12. This account setup process can also be performed at www.5thdm.com for instance, may be accessed and managed on a desktop or other type of computer. Compare FIG. 17. The dotted lines in FIG. 22 indicate the extent of the screenshot on a display provided by a smartphone or other device.

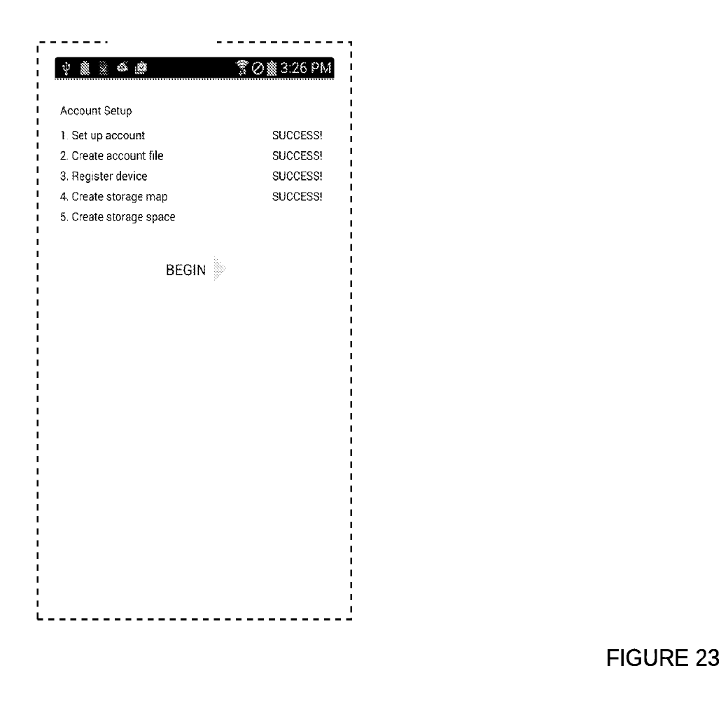

FIG. 23 is an exemplary screenshot of a stage of the 5th Dimension Mobile application installation process as introduced in FIGS. 12 and 22. The dotted lines in FIG. 23 indicate the extent of the screenshot on a display provided by a smartphone or other device.

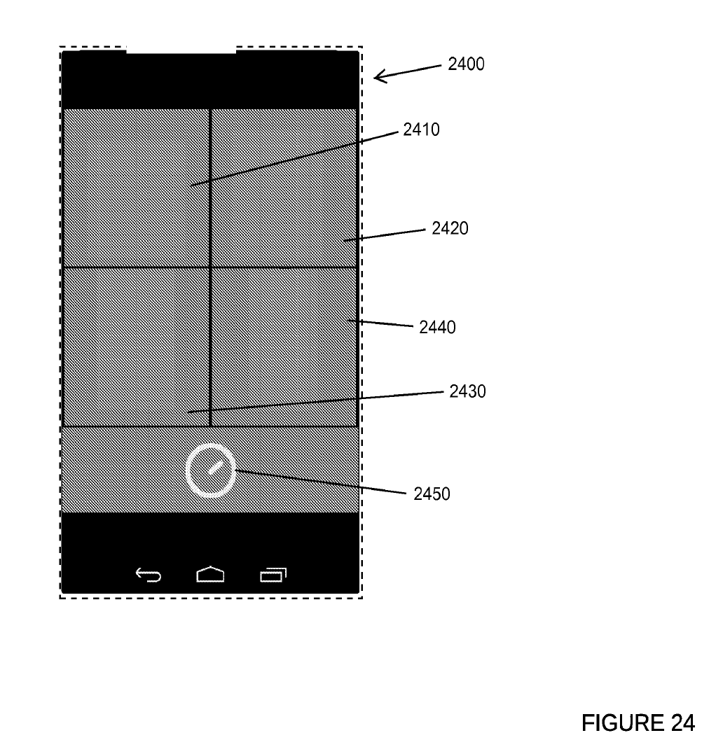

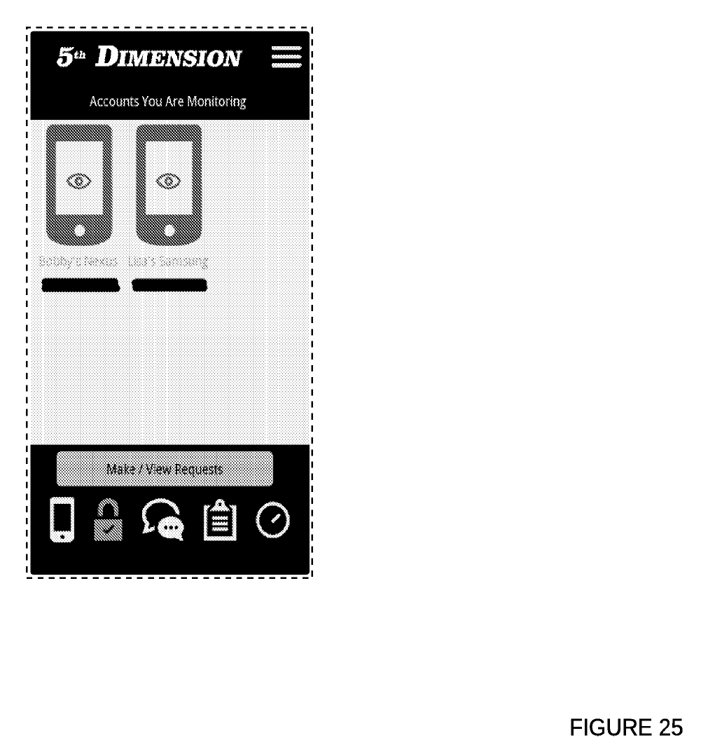

FIG. 24 is an exemplary screenshot of a main 5th Dimension Mobile application screen 2400. Here, the user can select and view 5th Dimension Core accounts, 5th Dimension MDNs, 5th Dimension Mobile accounts, and routine MSS messages in an integrated screen from button 2410 (see, e.g., FIG. 27); view other 5th Dimension Mobile accounts the user is monitoring from button 2420 (see, e.g., FIG. 25); synchronize data to another device (e.g., in the event a primary phone is lost or damaged) from button 2440; and check devices on which the user has loaded 5th Dimension Mobile Application from button 2430. Selecting clock icon 2450 provides access to account settings. The dotted lines in FIG. 24 indicate the extent of the screenshot on a display provided by a smartphone or other device.

FIG. 25 is an exemplary screenshot of 5th Dimension Core accounts being monitored. The dotted lines in FIG. 25 indicate the extent of the screenshot on a display provided by a smartphone or other device.

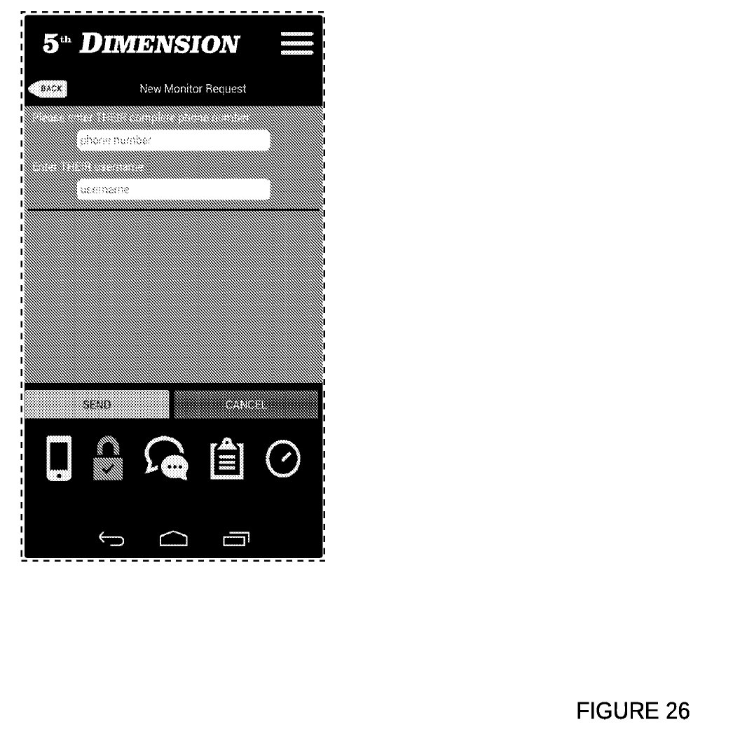

FIG. 26 is an exemplary screenshot of 5th Dimension Core monitor request. The dotted lines in FIG. 26 indicate the extent of the screenshot on a display provided by a smartphone or other device.

FIG. 27 is an exemplary screenshot of 5th Dimension Mobile application engagements, particularly showing names and logos of MDN client members such as businesses. The dotted lines in FIG. 27 indicate the extent of the screenshot on a display provided by a smartphone or other device.

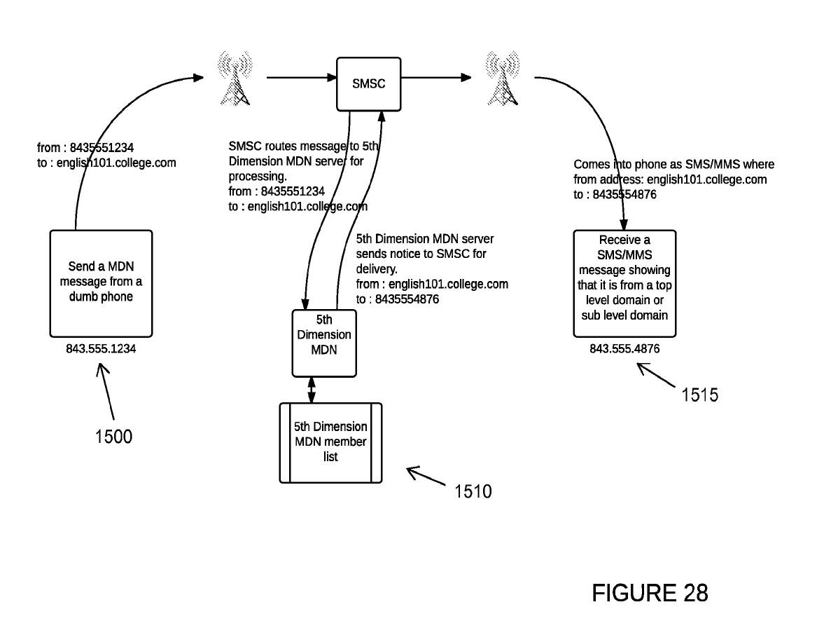

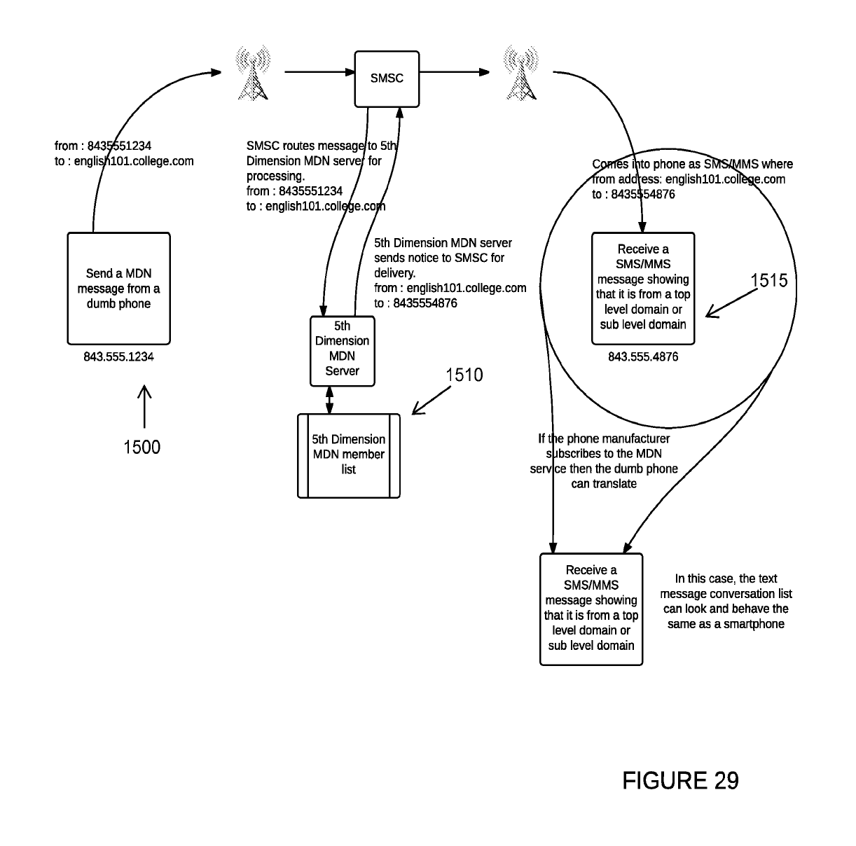

With reference now to FIGS. 28 and 29, a business or owner of the MDN or unique text identifier described above can elect to display its unique text identifier in a message conversation list such as that shown in FIG. 27 or even on a regular or “dumb” phone. As shown in FIGS. 28 and 29, an MDN message can be sent from a regular cell phone 1500. An SMS Center (SMSC) in communication with the 5th Dimension MDN application servers recognizes that, in this example, “english101.college.com” is an MDN address and sends the message to the MDN server for processing based on a member list 1510 and in accordance with protocols in FIGS. 11, 15 and 19. The inventive software can translate or disassemble a unique text identifier and address field for an end-user. The address field may take different forms, such as the examples shown in Table 1 below.

TABLE 1

| | |
|---|---|
| Telephone number: | +18435551234 |
| Email format: | English101.college.com@somedomain.com |
| Email format: | 8435551234@somedomain.com |
| MDN format: | Subdomain.top-level domain |
| MDN format: | college.com |
| MDN format: | English101.college.com |
| MDN format: | Crs1019am.english101.college.com |

As further shown in FIGS. 28 and 29, notice is returned to the SMSC for delivery “from: english101.college.com” to the end-user 1515. The message is received at the end-user device 1515. As particularly shown in FIG. 29, if a device manufacturer subscribes to the MDN service, a regular phone can display the unique text identifier to the end-user phone such that it appears similar to FIG. 27 rather than just showing that the message is from top level domain or sub level domain such as “english101.college.com”.

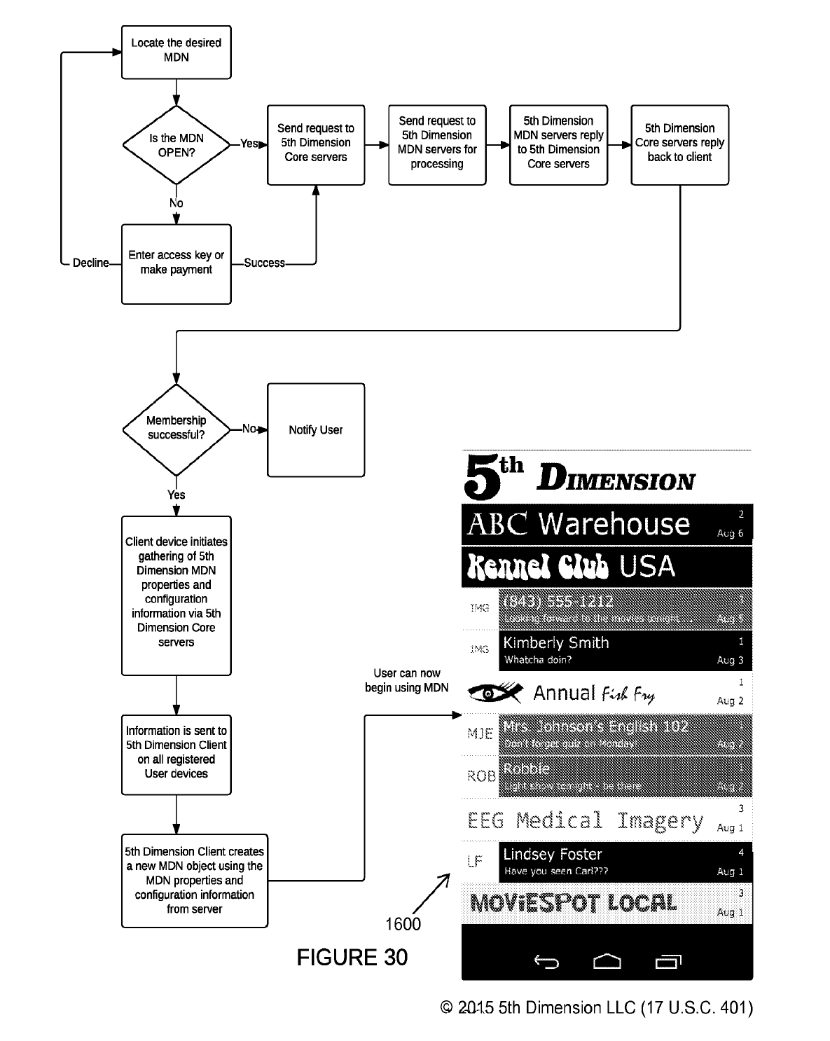

Turning to FIG. 30, with reference to FIG. 24, an end-user or client can subscribe to or join an MDN made known to the user by radio, TV, computer pop-up or other advertising venues. Here, the user can join an MDN if it is open or if, in this example, payment is successful. The 5th Dimension Mobile application will initiate gathering MDN properties and configuration information via 5th Dimension Core servers as shown in FIG. 18. The 5th Dimension Mobile application will create an MDN object on the client device, and the client can begin using the MDN. Once properly configured, the end-user device might display a screen shot 1600, as explained for FIG. 27.

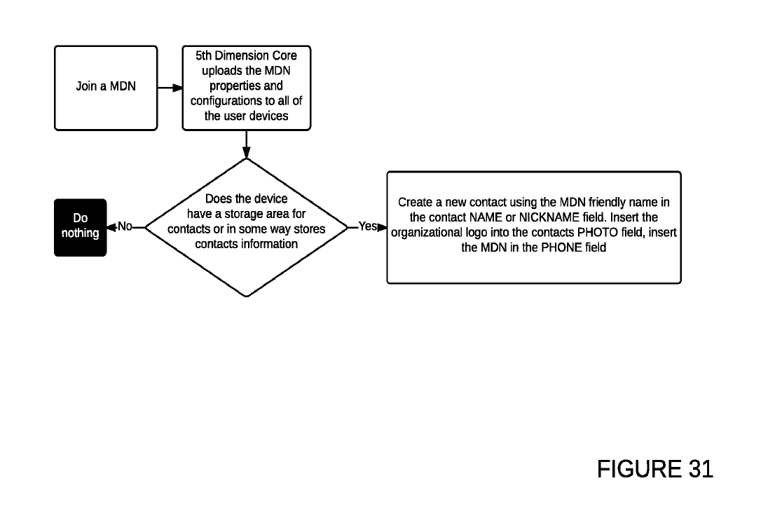

In FIG. 31 the client or end-user joins an MDN but is not using a 5th Dimension Mobile application on the user device to manage MDNs. Here, the user creates a new contact record using properties of the desired MDN. Specifically, the contact record is created by inserting a Friendly Name in a name field. The MDN image may be inserted in a photo field, and the MDN is inserted in an address field such as a phone number or email address.

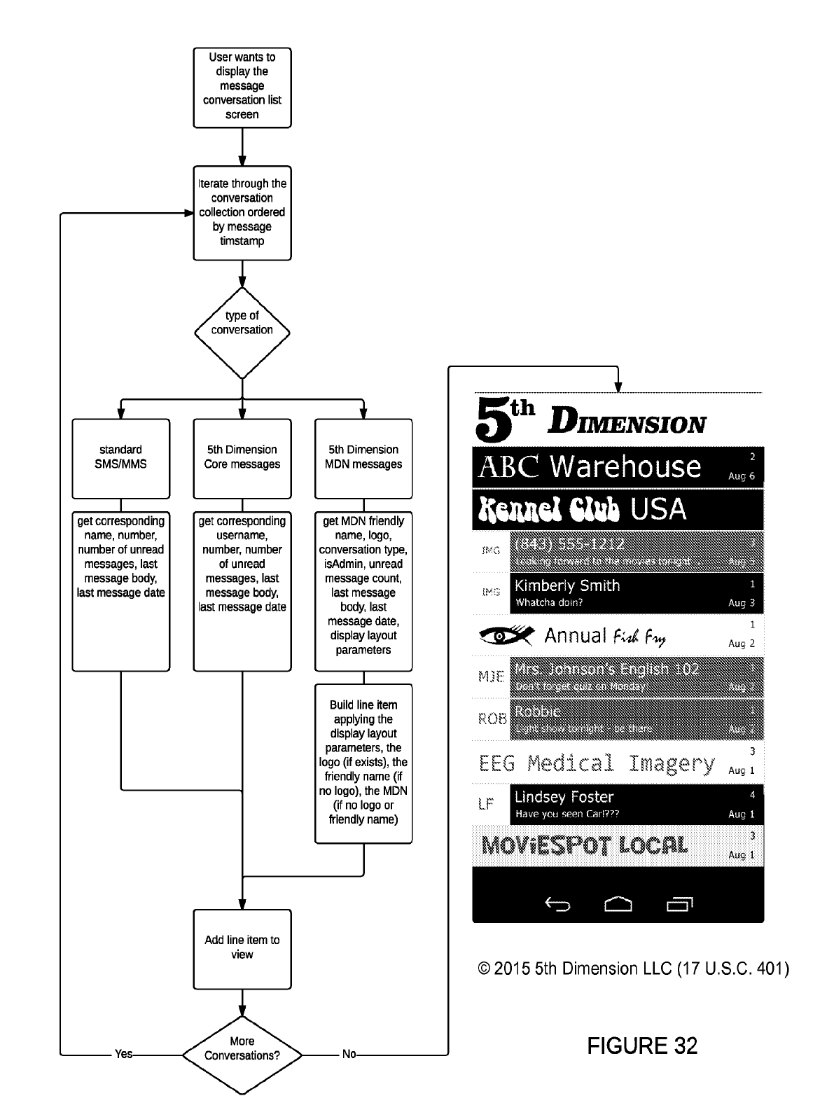

FIG. 32 shows what an end-user can do to display a message conversation list such as the example shown in FIG. 27. Here, the list of conversations is stored on the client device, either separately or in one collection. If the conversations are stored in different collections, at the time the user wishes to display the conversation list, a new temporary list is formed by iterating through collections in accordance with FIG. 20A.

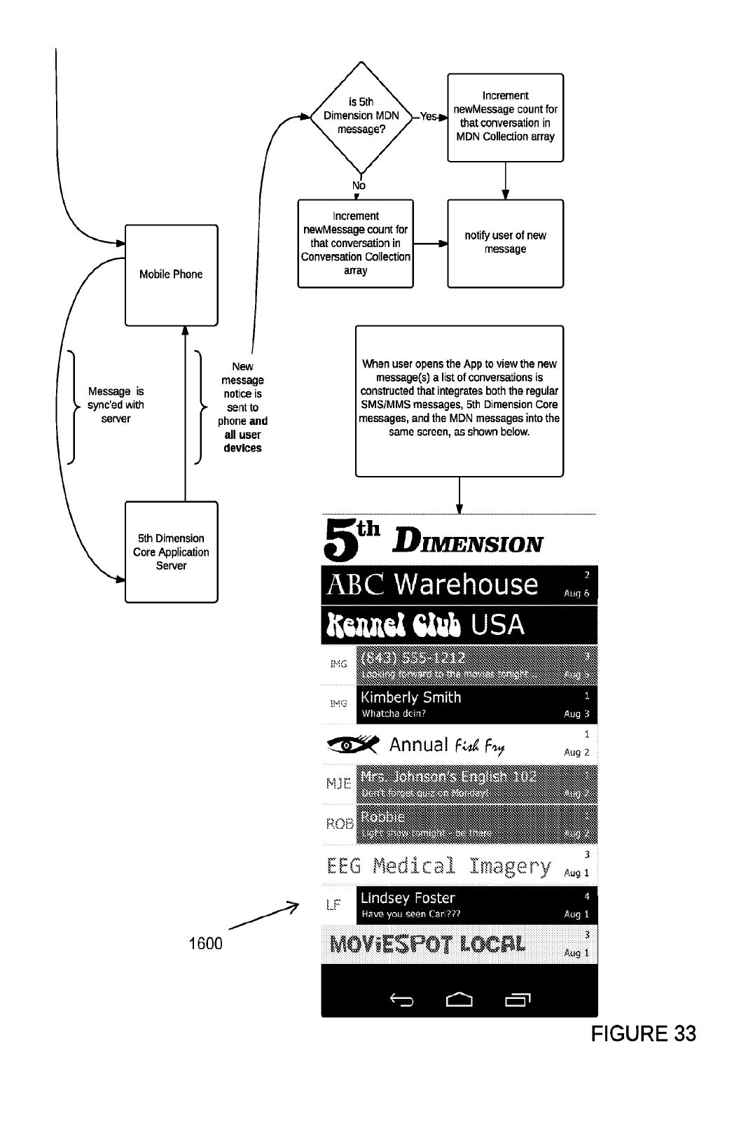

With reference now to FIG. 33, a process is shown for viewing a list of conversations that integrates regular MSS messages and MDN messages. Specifically, the protocol of FIG. 20A assesses whether an incoming message is an MDN message and increments a new message count in Conversation MDN or Conversation Default array. The mobile phone receives a new message, thereby notifying the user of the new message. When the user opens the 5th Dimension Core application to view the message, the integrated messages are displayed on the device screen 1600.

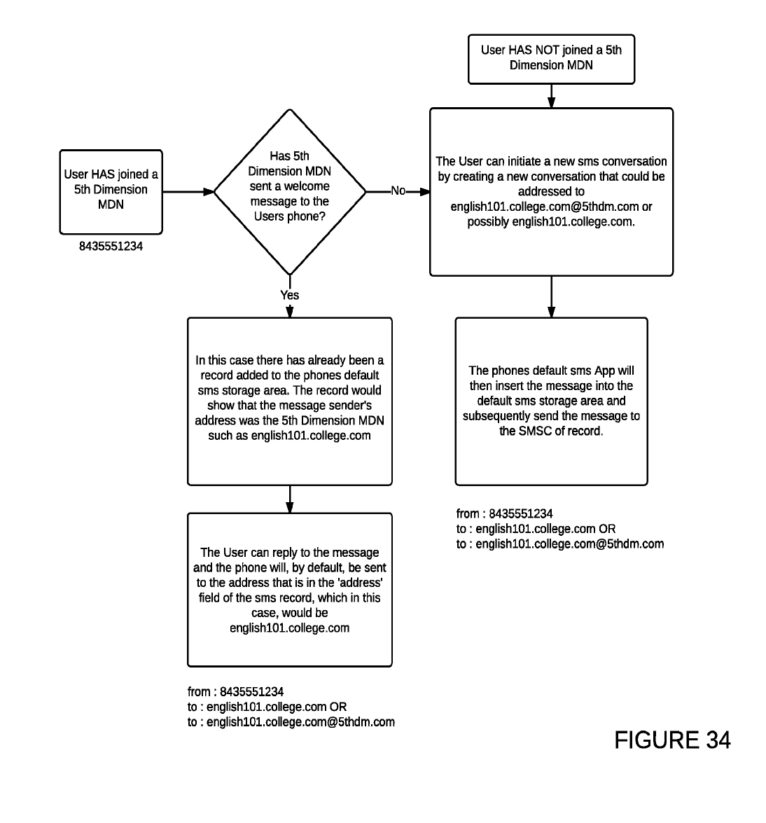

FIG. 34 shows a user having a mobile phone that does not include compatible MDN software such as a 5th Dimension Mobile application. However, the user previously joined an MDN service using available methods (via phone, computer, website, and etcetera). In this example, the mobile phone default SMS capability may be exploited by the MDN system. Specifically, the user can initiate an SMS conversation by addressing, for instance, “english101.college.com@5thdm.com”. The standard SMS application of the mobile phone will insert the message into the SMS storage area and send the message to the SMSC. See FIG. 29.

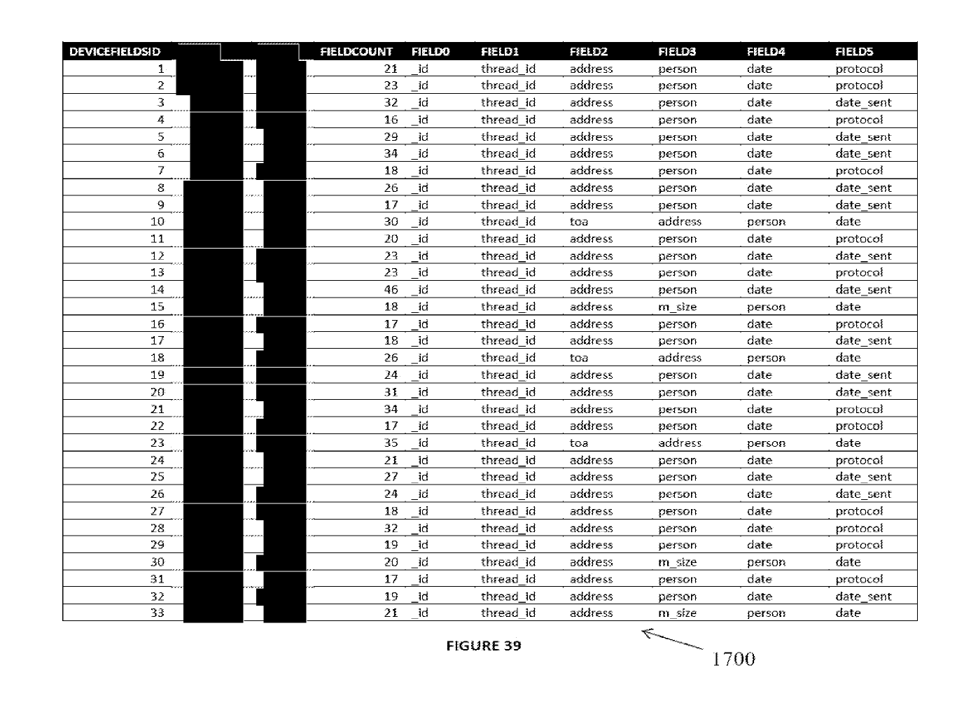

FIG. 34 further shows that in the event an MDN record has been previously added to the storage area of the phone, the message sender's address display will show, for instance, “english101.college.com”. The user can reply to the message and the phone will, by default, send the reply to the address in the address field of the SMS records, which in this example will be to “english101.college.com”. Mapping and management of the address field is described below in more detail with respect to FIG. 39.

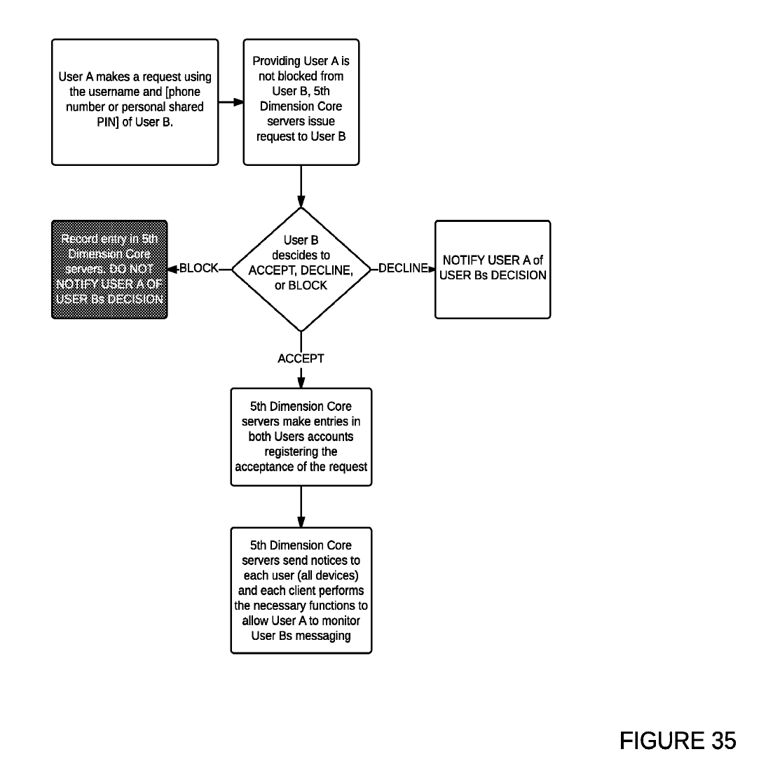

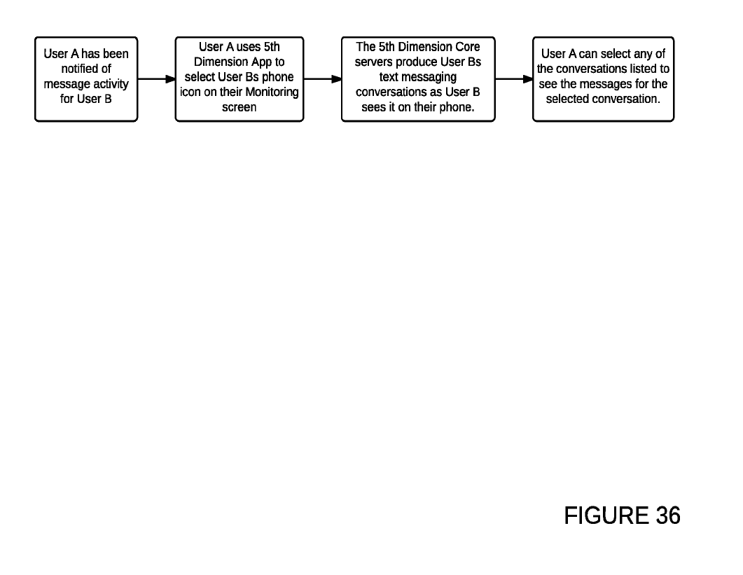

Turning now to FIGS. 35 and 36, another aspect of the disclosure is directed to monitoring messages of one user by another in real-time. Specifically, FIG. 35 is directed to User A and User B, both having the 5th Dimension Mobile application installed on their respective communication devices. In this example, User A wishes to monitor User B's messages and requests permission to monitor User B. User B may accept, decline, or block. The 5th Dimension Core server records the request and result and modifies the accounts accordingly. The users are alerted to next steps to allow monitoring.

FIG. 36 shows a result of the monitoring request and acceptance in FIG. 35 from a perspective of User A. Here, as also shown in FIGS. 16 and 17, User A may use any registered device to view all of User B's conversations and messages just as if User A were holding User B's phone in hand. User B is not aware if and when User A is monitoring a particular message. Additionally, User A has the ability to prioritize or select any listed conversation for monitoring.

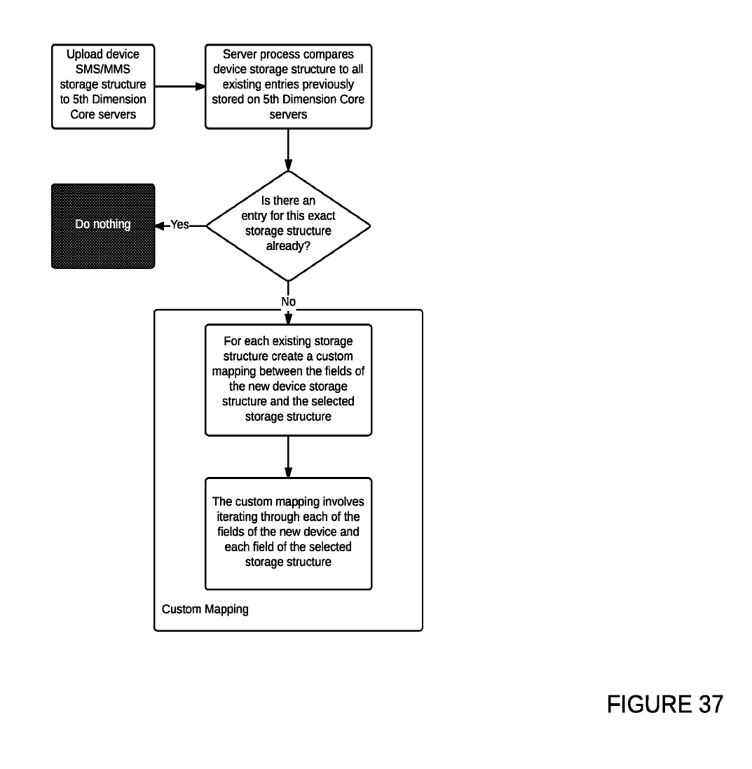

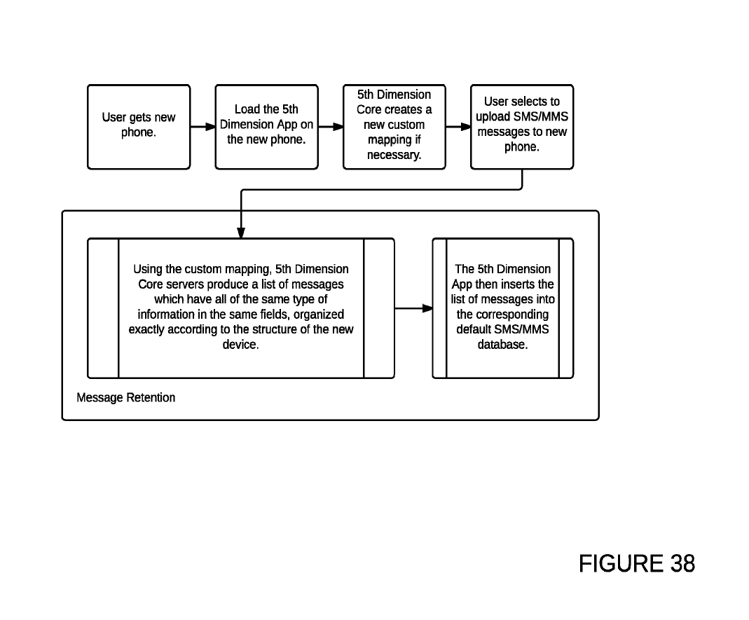

With reference to FIGS. 37 and 38, processes for transferring data, particularly text messages from one communication device to another, are shown. In FIG. 37, a device storage structure (see FIG. 39) is mapped and uploaded to a 5th Dimension Core server. The server compares the storage structure to existing entries. If there is no exact storage structure for the specific device, a mapping process is customized to map fields of the new device and selected storage structure. The custom mapping in accordance with the inventive software protocols above involves iterating through each field of the new device and through each field of the selected storage structure as explained with respect to FIG. 39 below.

FIG. 37 particularly shows the custom mapping, which is a key component offered by 5th Dimension that contains the unique ability to correctly move SMS and MMS messages from one type of mobile phone to another, so that they retain as much original properties and information as when they were originally created.

The process begins when the 5th Dimension Mobile application is installed on a user's mobile phone. A background process queries the phones default SMS and MMS database tables to see how many fields exist and what their label is. This information (device footprint) is then sent to the 5th Dimension Core server for processing.

A server process begins with performing a query to a specific database table (DeviceFieldsTable) that contains each recorded unique configuration (footprint). For example, a particular phone may have an SMS table that has 17 fields with accompanying field names. The server process first searches to see if an entry already exists that matches the same 17 fields with the same exact field names. If the entry exists, then the process is complete and no further work is necessary. If the entry does not exist, the process adds the new unique configuration to the DeviceFieldsTable in the 5th Dimension Core Database. Providing a successful insertion, the process then begins to create the custom mapping entries that allow the 5th Dimension Mobile Application and Core combined to bring any and all existing messages from a first phone into a second phone, all automatically, in the correct format, retaining the most amount of transferrable information for each message, with a press of a button in the 5th Dimension Mobile application.

The 5th Dimension Core database table named DeviceMapTable contains entries that allow for the custom mapping necessary to accurately move messages from one phone to another.

With further reference to the custom mapping process, when the first ‘footprint’ is entered into the DeviceFieldsTable there is no mapping to be done, therefore no entry exists in the DeviceMapTable. As the second ‘footprint’ is introduced and found to be different the mapping process begins.

The process begins by retrieving all existing entries from the DeviceFieldsTable. This is a list of all ‘footprints’ listing the number of fields and the corresponding name of each field. For each ‘footprint’ the process compares each field name with the corresponding field name of the newly inserted ‘footprint’. For instance, viewing the first field in the new footprint and assuming it is named ‘_id’ and the corresponding first field of the resultset entry where the cursor is currently located, it too may be labeled ‘_id’. Comparing the two labels, if they are found to be the same the process then moves to the second field name of the newly inserted ‘footprint’ and starting at the first field of the resultset entry, iterates through each field name to see if they are a match. The process iterates through each field name until it either reaches a match, ‘date’ and ‘date’, or, the end of the field names has been reached of the current resultset entry. During this process, a separate array keeps track of the matches if one is found and nothing if a match is not found. As shown for example in Table 2:

TABLE 2

| | |
|---|---|
| | specific entry in resultset |
| newly inserted ‘footprint’ | where cursor is currently |
| (footprint) | pointing to (looking at) |

| field index (from) | field name | field index (to) | field name |
|---|---|---|---|
| field0 | _id | field0 | _id |
| field1 | thread_id | field1 | thread_id |
| . . . | . . . | . . . | . . . |
| field12 | smscenter | field15 | smscenter |
| field13 | delivered | no match | — |

After iterating through all fields for the newly inserted ‘footprint’ an entry is made into the DeviceMapTable that contains the from _id as the unique id of the newly inserted ‘footprint’, the to _id as the unique id of the resultset entry just iterated over, the specific field index (from), and the specific field index (to). Once this is successfully entered, the process is then reversed by comparing each field in the ‘looking at’ to each field in the ‘footprint’. This creates a custom mapping from and to each and every variation of footprint that is introduced to the 5th Dimension Core servers. This process is duplicated for each existing entry in the resultset from the DeviceFieldsTable.

With more particular reference to FIG. 38, a process for moving MSS (SMS/MMS) messages from one device to another is shown in which the devices have different storage schema. In this example, a user purchases a new smart phone. The 5th Dimension Core application is loaded on the new phone. The 5th Dimension Core application custom maps in accordance with FIG. 37, as necessary. The user then decides which messages to transfer to the new phone. The 5th Dimension Core application inserts the mapped messages into a corresponding default SMS/MMS database and the user will be able to display the messages seamlessly just as they appeared on the previous phone. Due to the messages residing on 5th Dimension Core server, the old phone is not needed for the transfer.

FIG. 39 shows a partial list of device SMS structures 1700, which includes an abridged field list for these devices. As shown, data is listed from six (6) fields for thirty-three (33) devices. Most of the 130 mapped devices known to the inventor have approximately 30 fields which include those shown in FIG. 39 as well as error code, priority, delivery date, offset and other fields. At least one device has sixty-seven (67) separate fields. Aside from varying types of information, many devices include the same information in different fields. For example, as FIG. 39 shows, Devices 1 through 9 include “address” in Field 2, but the “address” is in Field 3 of Device 10. Accordingly, as described above with respect to FIG. 37, the server must compare any new device to the mapped structures of FIG. 39. If a structure is not found, a custom field structure will be compiled according to this aspect of the disclosure, so that, for instance, an MDN™ component can be inserted in the proper field for “address” as in FIG. 31.

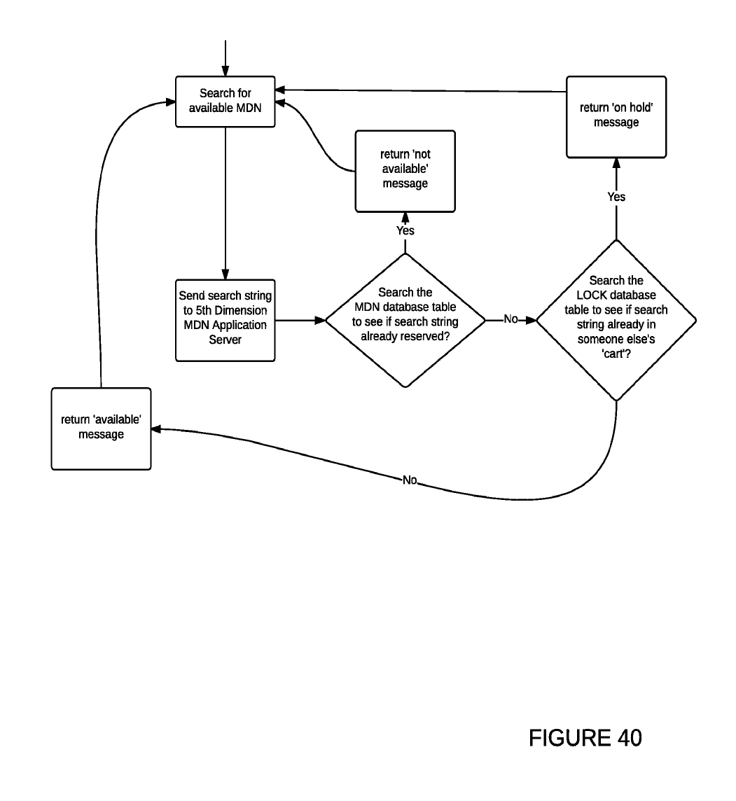

FIG. 40 is a flowchart showing a process of a 5th Dimension website visitor searching for available MDN(s). Here, an input box on the website allows visitors to enter a string that follows the same character limitations that regular internet domain URL naming conventions follow. Pressing the ‘check’ button sends the string to the 5th Dimension MDN server to see whether the search string is available. First, the server process checks to see if the search string is already registered. If already registered, the server responds with a ‘not available’ message. If not already registered, the process then searches the LOCK table to see if the same search string is already in someone else's cart. If yes, then an ‘on hold’ message is returned to the visitor. Otherwise, if the search string is not found in either table, an ‘available’ message is returned to the visitor. If the ‘available’ message is returned, a JavaScript function on the browser will display a prompt asking whether they would like to place the MDN into their cart.

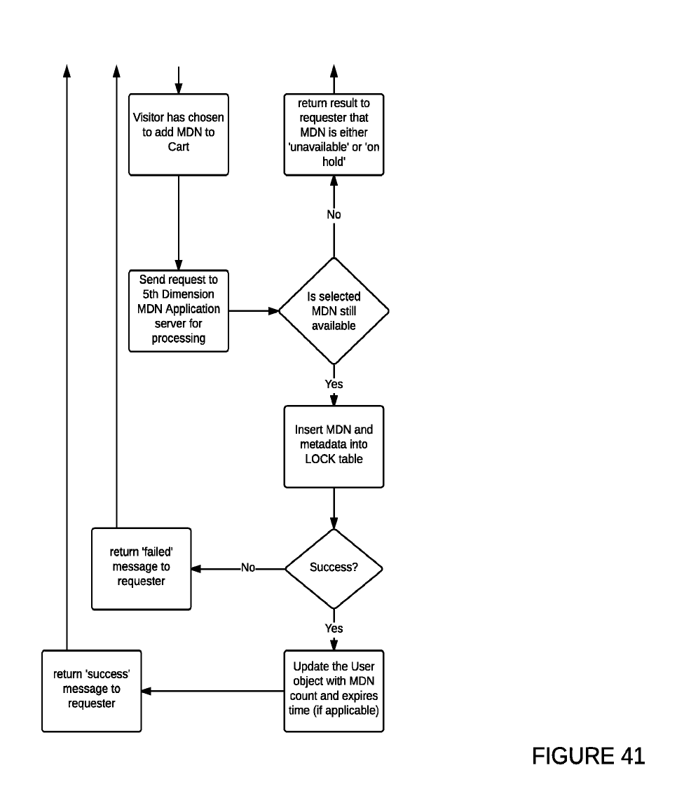

FIG. 41 is a flowchart related to FIG. 40, which shows the search string (MDN) is available. Here, the visitor is given the choice to add it to their cart. Selecting ‘yes’ will initiate the following process. The arrows at the top of the figure represent data sent (up) and received (down) by the 5th Dimension MDN server.

The 5th Dimension MDN server receives the request to add the MDN (search string) to the cart. First validating that the requested MDN meets guidelines for characters (again), then a check is made to make sure the MDN does not exist in the MDN database table or the LOCK database table (again). If no records exist then the MDN is ready to be inserted into the LOCK table.

The User object that is created when the websocket is created is linked with the visitor's websocket connection. By default the User object lockTime property is initially set to zero (0). This value is used by the 5th Dimension MDN Lock Time Controller to manage active or expired carts.

When adding MDNs, FIG. 41 shows that it is necessary to determine, for timer purposes, whether this is the first MDN this visitor wishes to add to their cart or not. If it is the first then the current Application server timestamp, in milliseconds, needs to be acquired. Using this, a new Date object is created that represents 30 minutes in the future. This new Date object becomes the expiration timestamp. At this point the server process has verified (1) the MDN meets the guidelines for acceptable characters, (2) did a check to make sure the MDN is available, (3) and determined whether the expiration timestamp is necessary. The MDN can now be inserted into the LOCK table. After doing so, the server sends a message to the visitor with the results (success or failure) of the request.

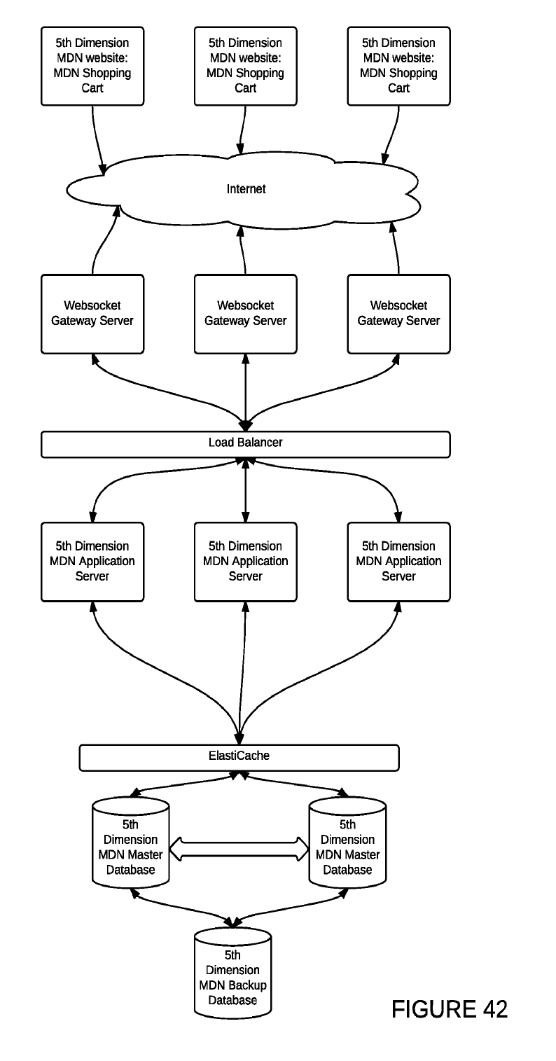

FIG. 42 shows a 5th Dimension Lock Time Controller. This is an Application on the 5th Dimension MDN Application server that monitors and manages the pool of available and locked (under contract in real estate terms) MDNs. MDNs follow the same process and principle as Internet domain URLs; e.g., purchaser buys a virtual piece of real estate on the Internet for an annual fee. MDNs are similar except the real estate and corresponding branding is in the present App is installed on mobile devices.

Moreover, in FIG. 42, the 5th Dimension website offers a search capability whereby, for example, someone who owns mywebsite.com can buy the same mywebsite.com on an annual basis. The purchaser has the opportunity to purchase several MDNs, fill a virtual shopping cart, and checkout. Unlike traditional domain URL sales, however, the present disclosure provides a timer to encourage shoppers to buy in a set time or the selection will time out and become available for another prospective purchaser.

Also relative to MDN registration in FIG. 42, the process of adding MDNs to the ‘cart’ consists of entering the Mobile Domain Name (ex. mywebsite.com) into a database table called LOCK along with relevant metadata. The User object keeps track of the number of MDNs in the cart and the cart expiration time in milliseconds. The Lock Timer operates on a 60 second cycle. The cycle begins with a database query to the LOCK table to get a resultset of any expired cart MDNs that have the same IP address of the requesting 5th Dimension MDN Application server. Iterating through the resultset, the process creates a JSON object containing the command to expire the cart. Using the session id, the correct SocketChannel is then used to send the JSON object is sent to the visitor's browser. Regardless of the success or failure of actually sending out the expire notices, the process then deletes all MDNs in the LOCK table for that specific visitor based on IP address and session id. Next, the process updates the specific User object to reset the number of MDNs in the cart to zero (0) and sets the lockTime to 0. Upon iterating through all elements in the resultset the cycle is complete.

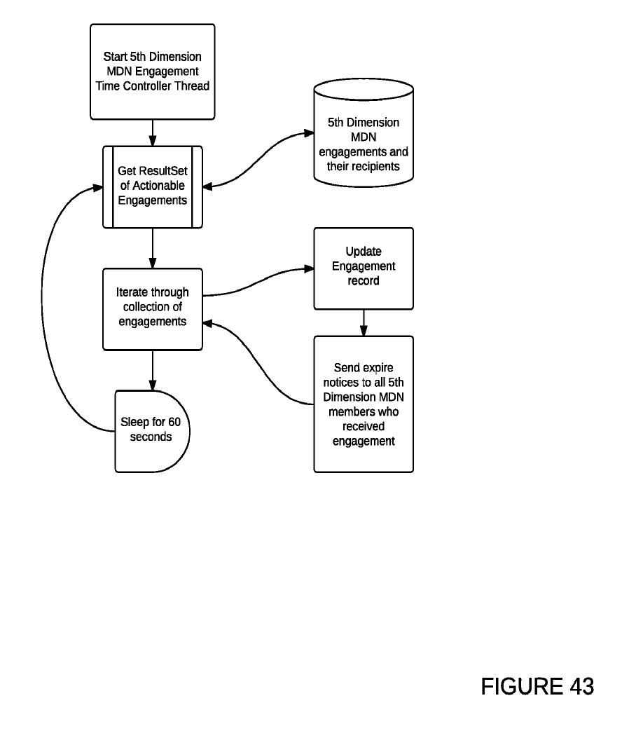

The flowchart of FIG. 43 shows that the 5th Dimension Time Controller is a separate Thread on the 5th Dimension MDN Application server that monitors and manages any and all engagements that have time constraints detailed by the creator. The Thread runs continuously while the 5th Dimension MDN Application is running on the server. Thus, engagements can be configured to start and end at any point from creation through any time in the future. The Time Controller has the responsibility of checking every 60 seconds to see if any such engagements exist that need to be started or ended.

At the beginning of each cycle, the predefined database query retrieves a resultset of engagements that have either just became active (ones who have a start date and time matching the current date and time and need to be sent immediately to designated recipients) or engagements that have an ending date and time that is the same as the time of the query. This produces a resultset of ‘actionable engagements’.

Next, per FIG. 43, iterating through the resultset the algorithm decides which open engagements have just become active and which engagements have expired. For newly active engagements, the engagement object is sent to all intended recipients. Likewise, for engagements that have just expired, an expiration notice is sent to all recipients who previously received the engagement. As the actionable engagements are processed, the database is updated to reflect the new status of each engagement, whether active or inactive.

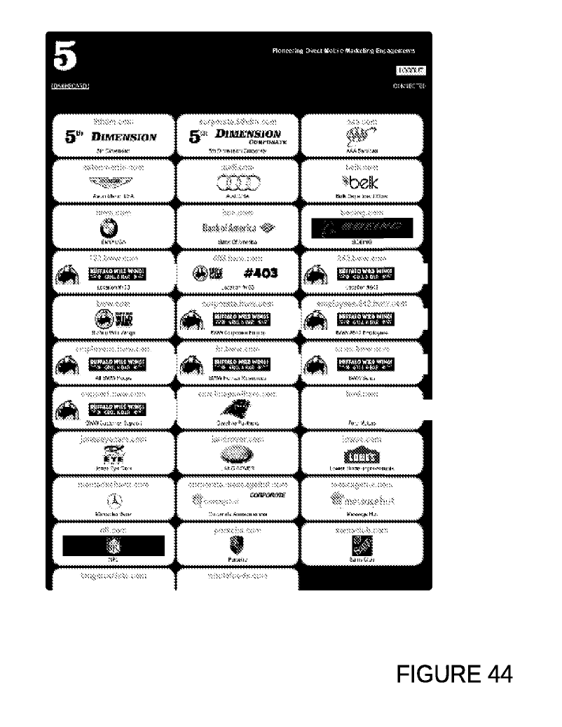

FIG. 44 is an exemplary screenshot of a device showing a dashboard according to an aspect of the disclosure. The dotted lines in FIG. 44 indicate the extent of the screenshot on a display provided by a tablet computer or other device.

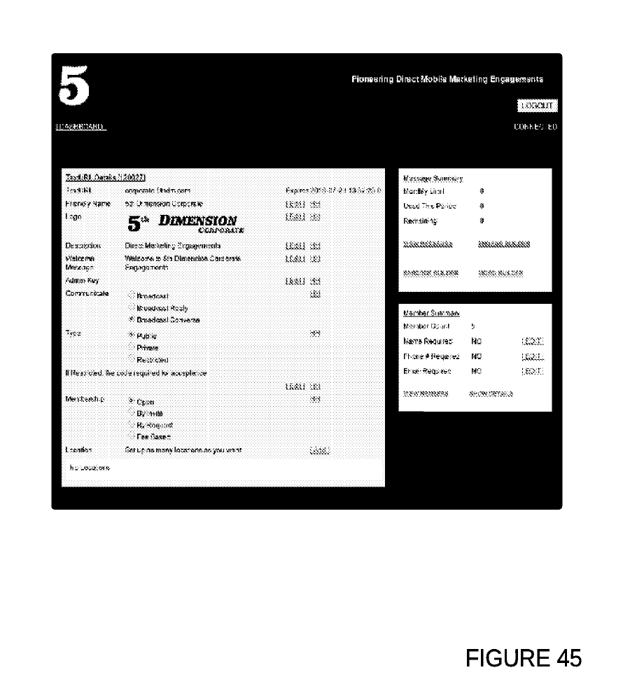

FIG. 45 is an image of a dashboard showing a set-up configuration according to another aspect of the disclosure. The dotted lines in FIG. 45 indicate the extent of the screenshot on a display provided by a desktop computer or other device.

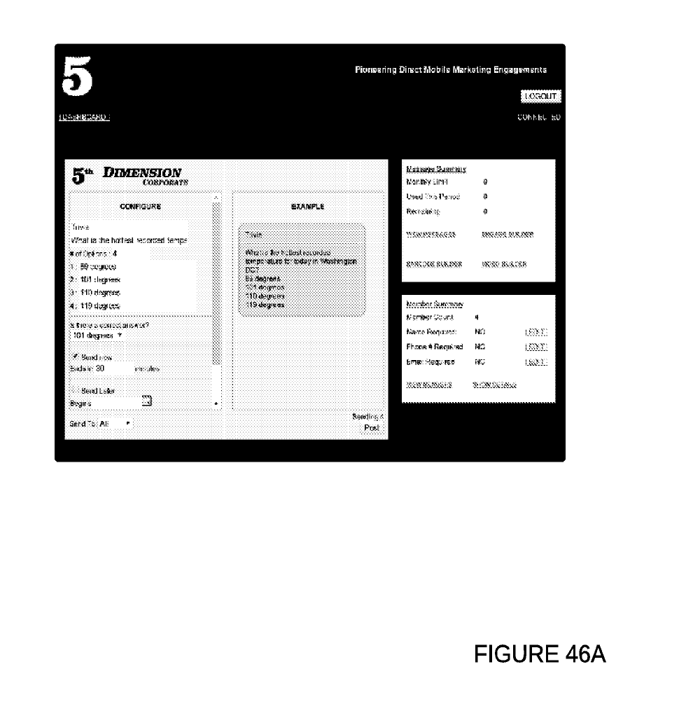

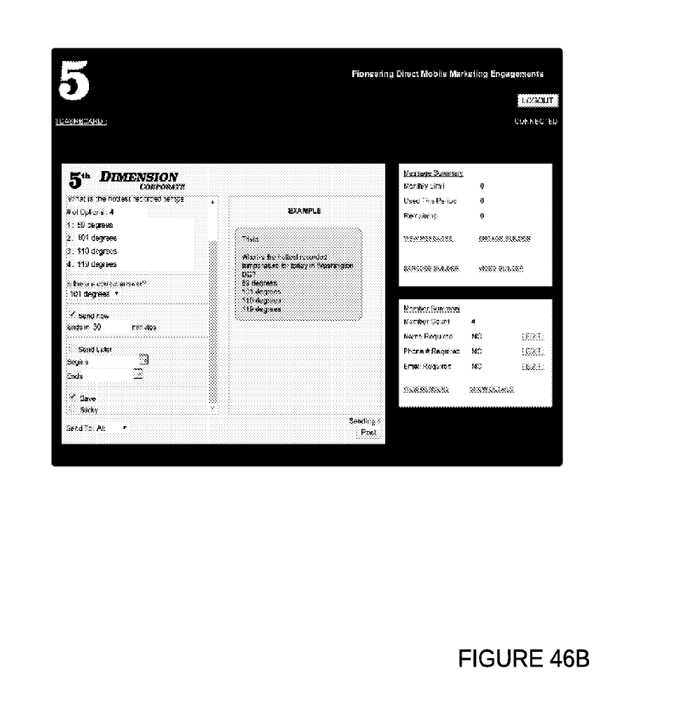

FIGS. 46A and 46B show the dashboard where a custom engagement can be created. The configuration controls are on the left side. As the engagement is created the user can see an example of it on the right side illustrating how it will appear on the 5th Dimension App as the end user will see it. The dotted lines in FIGS. 46A and 46B indicate the extent of the screenshot on a display provided by a desktop computer or other device.

The first input box is the engagement title followed by the engagement header. As in the case of a trivia question, the number of options is entered which will then build and display the requisite number of input boxes to be filled in. The correct answer checkbox allows the answer to be stored so that when the recipient makes a selection the answer can be shown immediately after and require no further action from the creator of the engagement.

Continuing the configuration on the left side as shown in FIG. 46A, an option to send now or send later is provided. If sending now, a time interval in minutes can be entered. If this is chosen and minutes are entered this will register with the 5th Dimension MDN server process thread that monitors and controls the active/inactive engagements. If sending later, a beginning and ending date and time (time not programmed in yet) can be specified. The 5th Dimension MDN server process thread will automatically send out the engagement and will invalidate the engagement at the specified ending date/time. If expiring, this will send a JSON Object that instructs the 5th Dimension App to expire the specific engagement. The App user will see this change reflected in the border color of the engagement—turning from green to black and disabling any clickable action or user action associated with usability. For barcodes it will alter the appearance of the barcode rendering it unreadable by scanning devices or readable usable information.

The ‘save’ option allows the MDN owner to create a library of engagements that can be reused. The ‘sticky’ option makes the engagement available to the MDN member regardless of when they joined the MDN. Under normal conditions, when someone downloads the 5th Dimension App or the white label equivalent and joins one or many MDNs, they only have access to messages and engagements from the time of joining and beyond. The ‘sticky’ option allows the new MDN member to see messages and engagements that were created at any time before they joined. An example case we are using includes a MDN owner who creates a campaign in advance of an upcoming event. All campaign engagements are selected as ‘sticky’ when created. On the day of the event, through public awareness or other methods, many new users will join the respective MDN. At that time they will be presented with all of the campaign engagements.

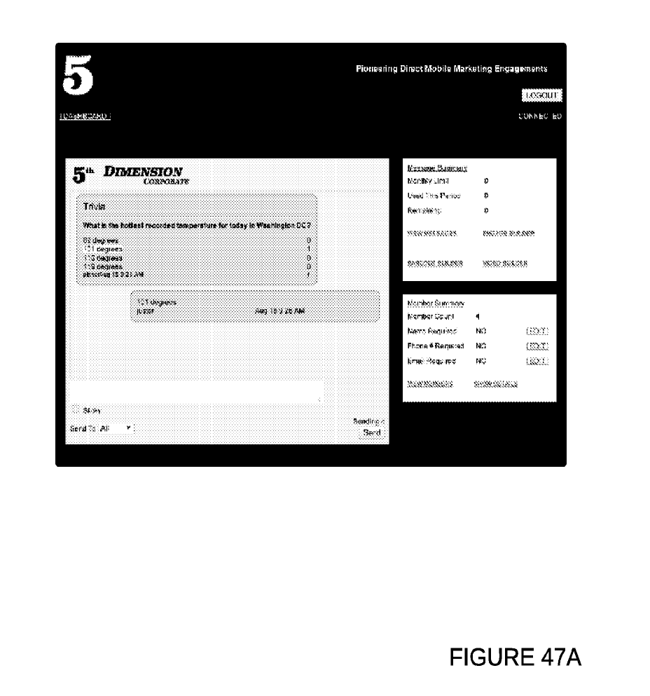

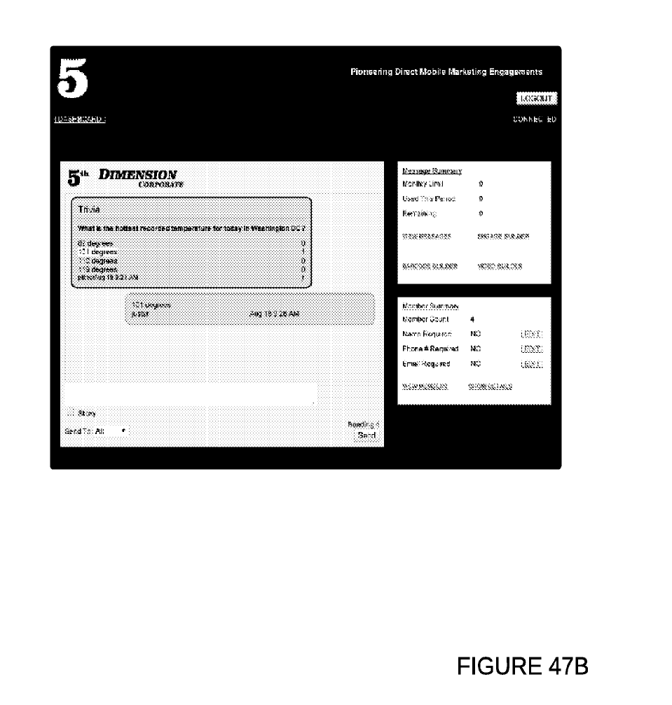

Turning to FIG. 47A, when the MDN owner creates the trivia engagement and sends it, the resulting answer from recipients is displayed for the creator to see, analyze, etcetera. The main display on the left shows the original engagement. In this example, because a correct answer was identified at the time of creation, it is displayed with a different color background. In this example, white. On the right of the engagement box are line totals showing the cumulative totals of all recipient answers for each answer and on the bottom right is the total number of answers received. As further shown in this example, the border of the engagement is green, which denote that it is still open and active. Finally, recipients' chosen answers are displayed right formatted, showing their username, the answer they selected, and the timestamp when their answer was logged with 5th Dimension MDN servers.

In FIG. 47B, the border of the engagement has changed to black automatically, in real time, when the specified active time period has elapsed. This is a visual indicator to alert the inactive state of the engagement. This example is a result of the 5th Dimension MDN server process thread that monitors and controls the active/inactive engagements. Notices are automatically sent to all MDN members who have not already answered the engagement and any respective MDN admin who is logged in and has access to the engagement. The dotted lines in FIGS. 47A and 47B indicate the extent of the screenshot on a display provided by a desktop computer or other device.

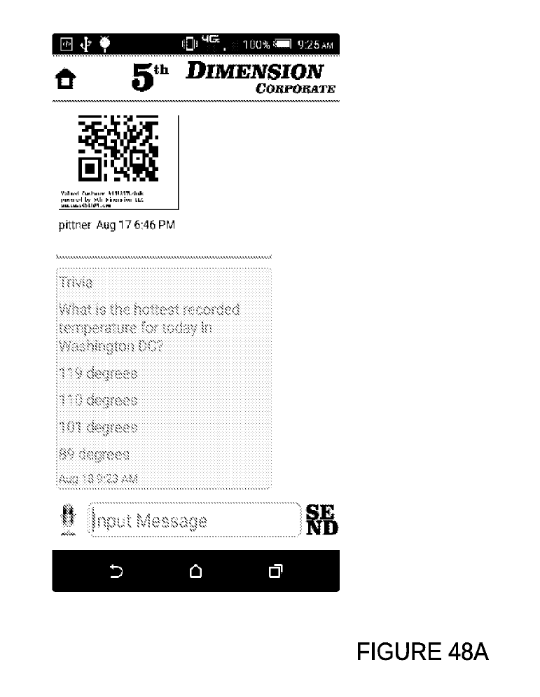

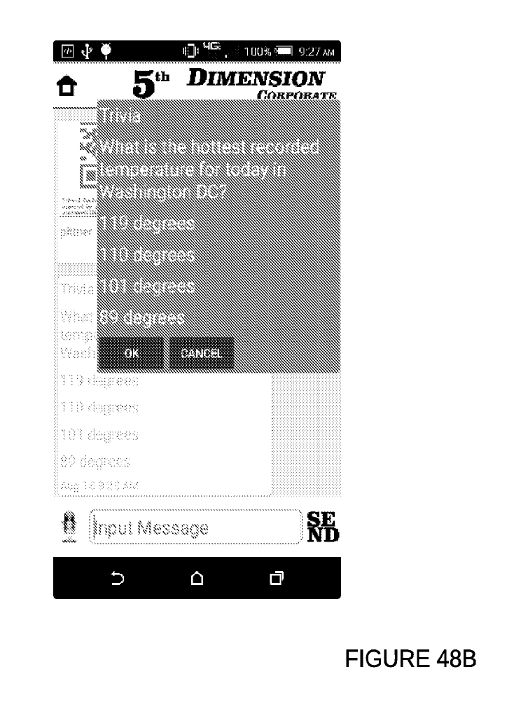

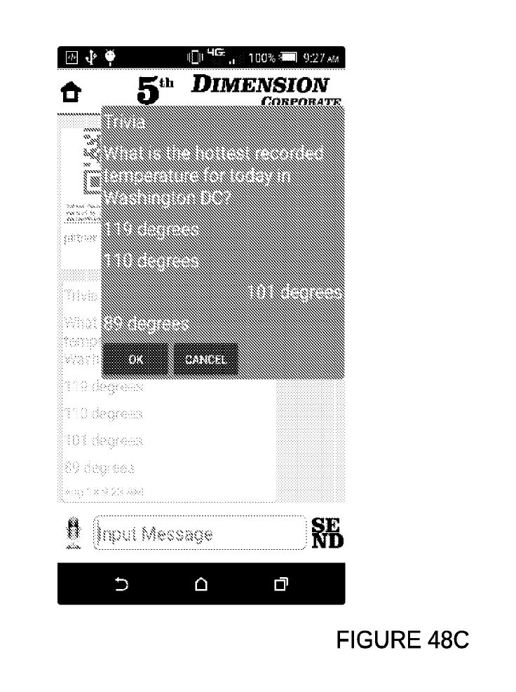

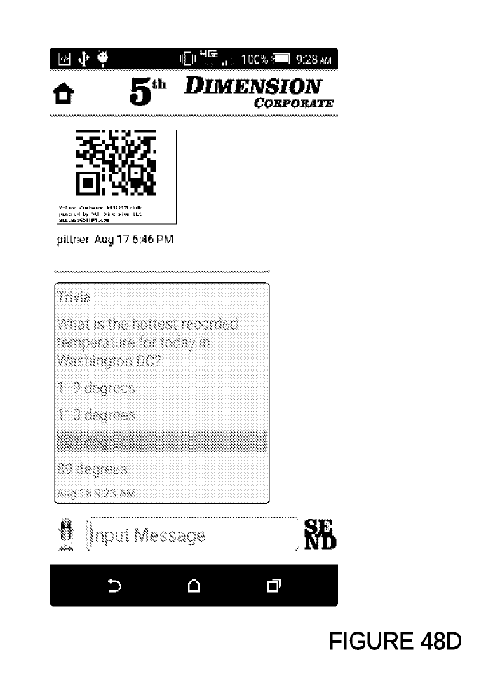

Turning to FIG. 48A, a view of the 5th Dimension App shows contents of the 5th Dimension Corporate MDN. An engagement created and sent to the MDN member is shown just as it was when created on the 5th Dimension Dashboard. This example shows a green outline to signify that it is active and eligible for answering. Here, a member simply presses anywhere within the engagement green border, and a popup box appears where the member can choose the desired answer, as shown in FIG. 48B.

FIG. 48C shows the popup box where the member presses the chosen selection that results in the answer shifting to “right justified” within the popup box. The member can change the selection, which will move the newly selected answer to the right and “left align” all others.

As shown in FIG. 48D, once the answer is chosen and the member presses “OK”, the information is sent to the 5th Dimension MDN servers for processing, which then issue a response to the member device and updates the engagement area on the screen. The border is changed to, e.g., black or other visual indicator that the engagement is inactive and it is no longer “clickable”, and the chosen answer is highlighted with an exemplary green background. In addition, if the engagement creator registered a correct answer then the correct answer may be shown at that time (not shown). The dotted lines in FIGS. 48A-48D indicate the extent of the screenshot on a display provided by a smartphone or other device.

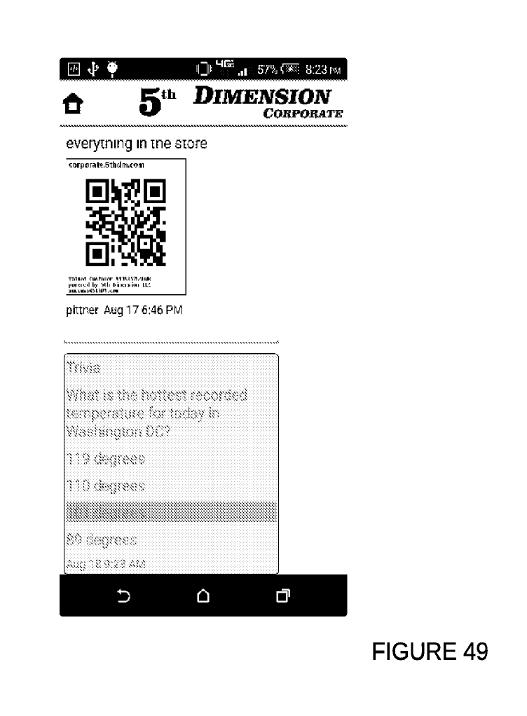

With reference now to FIG. 49, this screenshot shows the difference when a 5th Dimension MDN is configured as BROADCAST only communication. If the MDN owner chooses to configure in such a way, then the 5th Dimension App and 5th Dimension white label App will not display the microphone at the bottom nor at the input box or SEND button. Otherwise, if the MDN is configured as a BROADCAST REPLY or BROADCAST CONVERSE the entire bottom line is displayed. Additionally, configuration changes are made in real time, which means that as the MDN administrator makes changes to the MDN configuration, the member will see the screen change in real time as they are looking at it. The dotted lines in FIG. 49 indicate the extent of the screenshot on a display provided by a smartphone or other device.

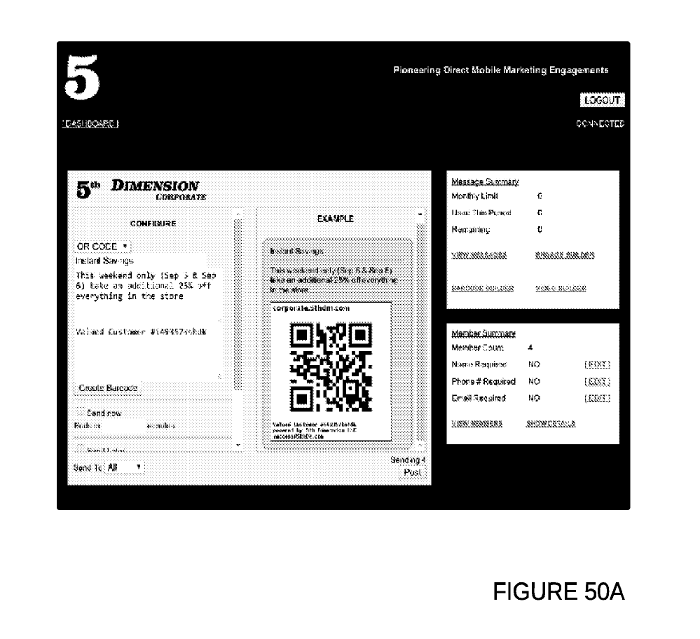

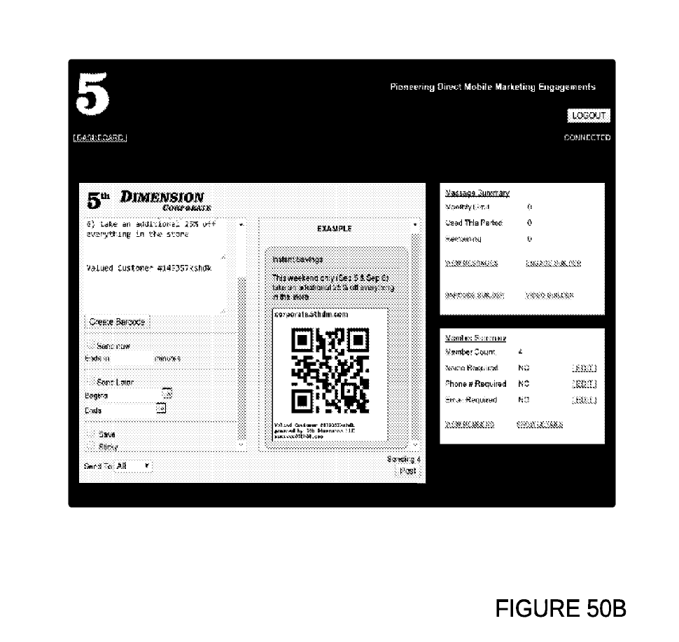

FIGS. 50A and 50B are screenshots of a dashboard builder. Specifically, these show the dashboard where a custom barcode can be created. The configuration controls are on the left side. As the barcode engagement is created the user can see an example of it on the right side illustrating how it will appear on the 5th Dimension App as the end user will see it. A first step is choosing the type of barcode to be created from the dropdown. Next, user input boxes are populated with desired title and the content that will be used to create the actual barcode. Clicking on the ‘Create Barcode’ creates a real time custom barcode image by triggering a JavaScript method that sends a request to the 5th Dimension MDN servers to create the custom barcode. The MDN server immediately creates the barcode image and responds with a JSON Object containing the newly created barcode image. The browser JavaScript method then adds the image to the right side of the screen in the illustrated example engagement. The dotted lines in FIGS. 50A and 50B indicate the extent of the screenshot on a display provided by a desktop computer or other device.

Continuing the configuration on the left side in FIG. 50A, an option to send now or send later is shown. If sending now, a time interval in minutes can be entered. If this is chosen and minutes are entered this will register with the 5th Dimension MDN server process thread that monitors and controls the active/inactive engagements. If sending later, a beginning and ending date and time (time not programmed in yet) can be specified. The 5th Dimension MDN server process thread will automatically send out the engagement and will invalidate the engagement at the specified ending date/time. If expiring, this will send a JSON Object that instructs the 5th Dimension App to expire the specific engagement. The App user will see this change reflected in the border color of the engagement, for example, by turning from green to black and disabling any clickable action or user action associated with usability. For barcodes it will alter the appearance of the barcode rendering it unreadable by scanning devices or readable usable information.

The ‘save’ option, shown for instance in FIG. 50B, allows the MDN owner to create a library of engagements that can be reused. The ‘sticky’ option makes the engagement available to the MDN member regardless of when they joined the MDN. Under normal conditions, when someone downloads the 5th Dimension App or the white label equivalent and joins one or many MDNs, they only have access to messages and engagements from the time of joining and beyond. The ‘sticky’ option allows the new MDN member to see messages and engagements that were created at any time before they joined. In this example, the MDN owner is creating a campaign in advance of an upcoming sales event. All campaign engagements are selected as ‘sticky’ when created. On the day of the event, through public awareness or other methods, many new users will join the respective MDN. At that time they will be presented with all of the campaign engagements.

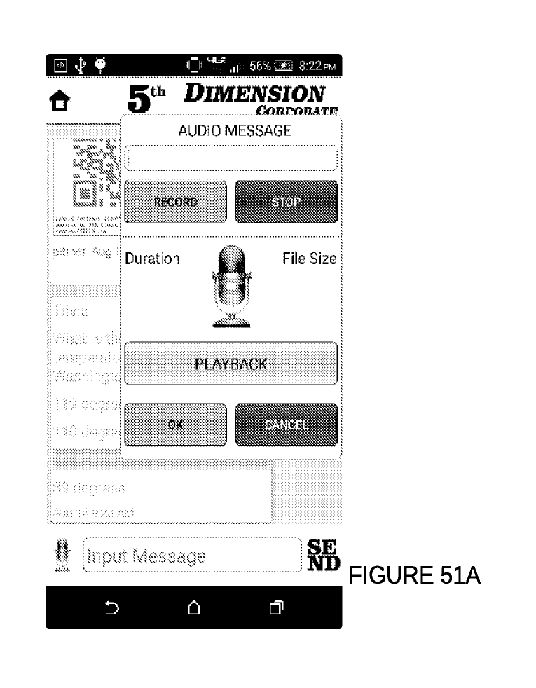

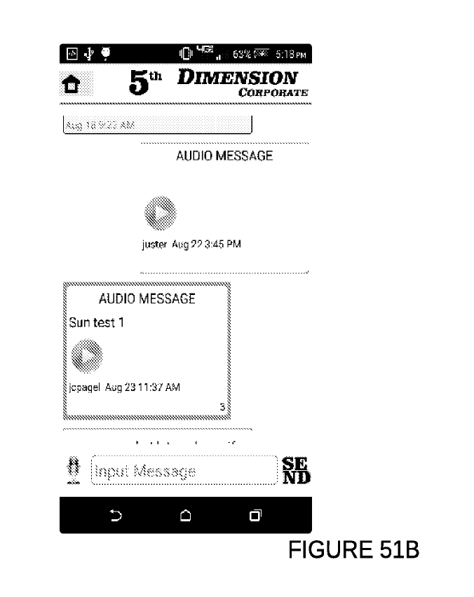

FIG. 51A is a view of a voice message recorder popup. The voice recorder uses the mobile devices default audio recorder to create an audio recording that can be sent to any 5th Dimension App user regardless of mobile device operating system, wireless service provider, or brand of mobile device. The dotted lines in FIG. 51A indicate the extent of the screenshot on a display provided by a smartphone or other device.

FIG. 51B is a screenshot of how a voice message might be displayed on the 5th Dimension App. Embedded in the MDN conversation, there can be many types of media, all of which can be displayed to allow the user to easily identify different types of engagements. In addition to other examples shown or contained herein, this example is how an audio message appears. Beginning with the AUDIO MESSAGE bordered with an exemplary green line, the user would press the PLAY button, and the App will use the device's default audio capabilities to play the audio message. One advanced feature programmed into the PLAY process according to this disclosure includes the ability to determine the preferred volume level so the user would most likely not have to make any effort to control playback volume. This is based on the availability and property of any available device volumes. For example, the device may have one or several volumes associated with different features; phone ringing (ringtone) has a volume level property, media playback has a separate volume level property, notifications have a separate volume level property, etcetera. Starting with identifying the different volumes available, if the media volume level is available then go with that directly, otherwise use ringtone (which may be on vibrate); otherwise take the average of the remaining volume levels.

Turning to AUDIO MESSAGE outlined in FIG. 51B with an exemplary blue border are several features. First, as with traditional text messaging, the conversations may justify left and right based on who the sender is. Messages that the user has sent are aligned along the right side and messages that have arrived from others are aligned along the left side. If the MDN has been configured with BROADCAST CONVERSE there is the potential for various levels of engagement between and amongst all the members of the MDN. The purpose of the blue border is to make it easily identifiable to the user of the device whether they have contributed to the conversation that is aligned on the left side of the screen.

FIG. 51B further shows an identifiable number on the lower right of the left aligned AUDIO MESSAGE. One of the features of the present engagement platform is the ability to have sub-conversations. This facilitates better “organization” or a “clean appearance” of the conversation screen. In this example, the ‘3’ denotes the number of messages that are directly associated with that thread. The blue border indicates to this user whether they have actual replied and participated in the sub conversation. For example, if the MDN has 40 members, and one sends a message to all members. It would appear on the left side of the screen. As some or all of the other members may participate in the engagement the number in the lower right will automatically increment. If this user presses on the engagement box it will show a list of all replies, posts, etcetera that others have posted. This user may choose whether or not to participate in the conversation. If they choose to participate, the blue border appears so they know they made a post with the engagement. The dotted lines in FIG. 51B indicate the extent of the screenshot on a display provided by a smartphone or other device.

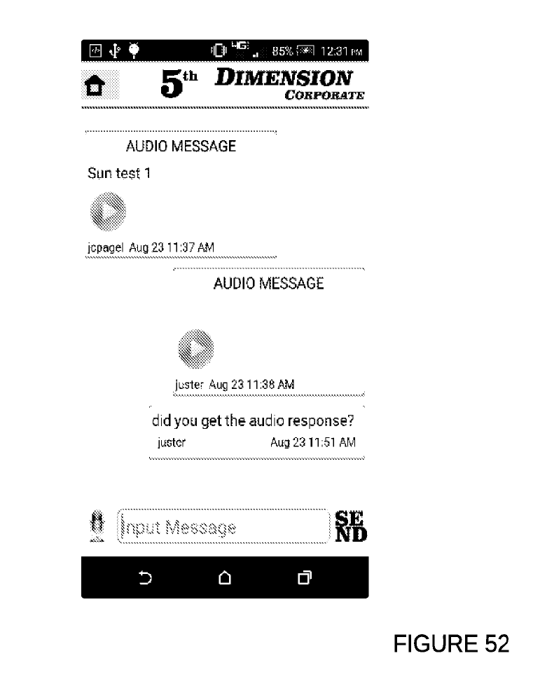

FIG. 52 is a screenshot of a conversation subthread. As shown, it is aligned as noted above, e.g., left and right justified, as a regular conversation screen. However, the present disclosure as shown in this example allows for consolidation of related engagements stemming from a particular engagement. The dotted lines in FIG. 52 indicate the extent of the screenshot on a display provided by a smartphone or other device.

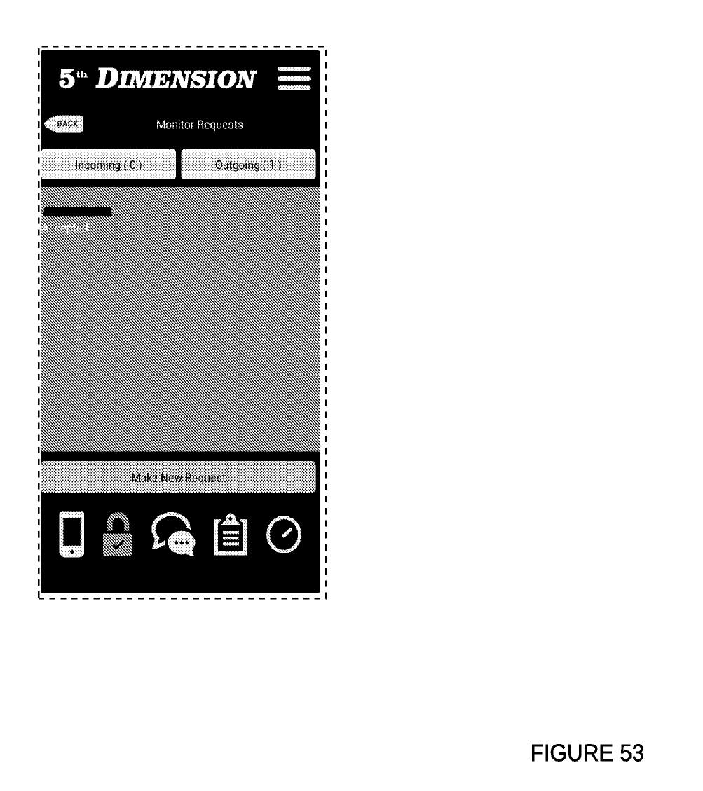

FIG. 53 is a screenshot that shows a comprehensive view of incoming and outgoing monitor requests. Two buttons along the top, for example, when pressed, display the respective list of monitoring requests and their current status. The dotted lines in FIG. 53 indicate the extent of the screenshot on a display provided by a smartphone or other device.

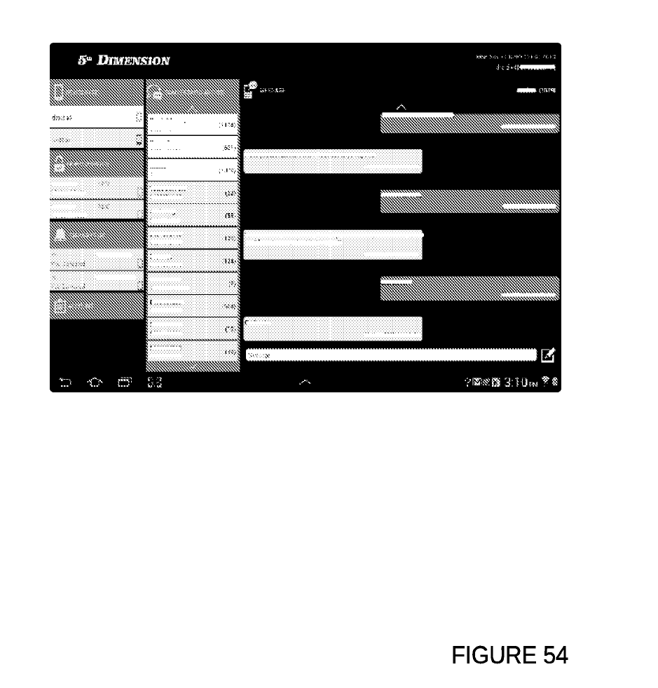

FIGS. 54 and 55 generally demonstrate a freedom to use all of 5th Dimension's capabilities while not being tied to a smaller mobile phone screen if so desired. The ability to use a larger tablet/TV/monitor screen and to use a standard keyboard offers unique advantages that are natively built in to the 5th Dimension experience. The dotted lines in FIGS. 54 and 55 indicate the extent of the screenshot on a display provided by a tablet computer or other device.

FIG. 54 more particularly shows a screenshot of the 5th Dimension App as it appears on tablets and TV screens in landscape mode. This screen does not show the newly integrated 5th Dimension MDN feature set. Once integrated, the ‘conversations’ list will show the 5th Dimension MDNs in their full brilliance and the ‘message’ area will show all elements of the engagement platform much in the same way it appears on the 5th Dimension App for smaller screens such as those of smartphones.

FIG. 55 shows a screenshot of a 5th Dimension Core member website login. From this unified dashboard, a user can perform all actions and activities as if performing the same functions on the 5th Dimension App or 5th Dimension white label application.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art. The trademarks and tradenames used herein belong to their respective owners, and should not be construed as use or endorsement of Applicant's services by those owners. Instead, they are used herein solely to illustrate the disclosed invention.

### EMBODIMENTS

### Embodiment 1

A system for assigning unique MDNs to digital content on a communications network, the system comprising:

an engagement platform application server being configured to manage digital content by:
generating unique MDNs;
populating a database of the unique MDNs;
receiving incoming connections from a web socket in electronic communication with the communications network, at least one of the incoming connections carrying an MSS associated with one of the unique MDNs;
identifying a unique MDN from the database as an associated MDN and assigning the associated MDN to the MSS;
configuring the MSS to form a configured MSS so that the associated MDN is displayed on a communications device when the configured MSS is displayed on the communications device; and
sending the configured MSS to the communications device.

### Embodiment 2

The system as in embodiment 1, wherein each unique MDN is selected from the group consisting of a logotype, a name, and combinations thereof.

### Embodiment 3

The system as in any one of embodiments 1-2, wherein the MSS is an SMS message addressed to the communications device.

### Embodiment 4

The system as in any one of embodiments 1-2, wherein the MSS is an MMS message addressed to the communications device.

### Embodiment 5

The system as in any one of embodiments 1-4, wherein the database of unique MDNs further comprises a user profile for each unique MDN.

### Embodiment 6

The system as in embodiment 5, wherein the user profile includes a symbol, a logotype, a name, or a mark, or a combination of two or more thereof.

### Embodiment 7

The system as in any one of embodiments 5-6, wherein the user profile includes broadcast and reply options.

### Embodiment 8

The system as in any one of embodiments 1-7, wherein the configured MSS is configured to be received by a communications device chosen from a personal computer, an intelligent phone, a mobile communication apparatus, or combinations thereof.

### Embodiment 9

The system as in any one of embodiments 1-8, further comprising a resolution application being configured to resolve the MSS and display the associated MDN on the communications device.

### Embodiment 10

The system as in embodiment 9, further comprising an incremented display including a conversation list integrating the MDN message and an SMS message.

### Embodiment 11

The system as in embodiment 9, further comprising an incremented display including a conversation list integrating the MDN message and an MMS message.

### Embodiment 12

The system as in any one of embodiments 1-11, wherein the resolution application dictates response options to an MSS message, the response options including no response, a group response, or a private response.

### Embodiment 13

The system as in any one of embodiments 1-12, wherein the configured MSS is sent to the communications device via at least one outgoing connection provided by at least one web socket in electronic communication with the communications network.

### Embodiment 14

A system for assigning discrete identifiers to digital content on a communications network, the system comprising:

a resolution application being configured to assimilate a communications device by intercepting and disassembling an MSS addressed to the communications device, the resolution application being further configured to resolve a text identifier associated with the MSS.

### Embodiment 15

The system of embodiment 14, wherein the text identifier comprises an MDN.

### Embodiment 16

The system of embodiment 14, wherein the text identifier does not comprise an MDN.

### Embodiment 17

The system as in any one of embodiments 14-16, wherein the resolution application identifies an MSS carrying an MDN.

### Embodiment 18

The system as in any one of embodiments 14-17, further comprising a resolution server being configured to identify an MSS containing an MDN, the resolution server in communication with the resolution application to display the MDN on the communications device.

### Embodiment 19

The system as in embodiment 13, further comprising an MDN server, the MDN server being configured to associate an MSS having an associated MDN selected from the group consisting of the associated MDN's symbol, logotype, name, mark, and combinations thereof.

### Embodiment 20

A system for assigning unique MDNs to digital content on a communications network, the system comprising:

a text application server being configured to manage digital content by generating unique MDNs such that no two MDNs are identical;
a database of the unique MDNs; and
a resolution application being configured to assimilate a communications device by disassembling an MSS addressed to the communications device, the resolution application being further configured to resolve a text identifier associated with the MSS.

### Embodiment 21

A method for managing digital content on a communications network, the method comprising:

providing a text application server being configured to manage digital content by generating unique MDNs such that no two unique MDNs are identical;
providing a database of the unique MDNs;
providing a resolution application being configured to assimilate a communications device by disassembling an MSS addressed to the communications device, the resolution application being further configured to resolve an MSS having an associated MDN and process a MSS that does not have an associated MDN;
providing a resolution application server and identifying an MSS from a sender communications device having the resolution application, the resolution application server being configured to recognize whether a receiver communications device has a companion resolution application;
   identifying whether the MSS from the sender communications device includes an associated MDN or is a non-MDN MSS,
   wherein, if the receiver communications device has the companion resolution application and the MSS from the sender is a non-MDN MSS, the MSS from the sender communications device is processed by the resolution application server, and
   wherein if the MSS from the sender communications device includes an associated MDN, the message from the sender communications device is sent to the MDN application server for processing.

### Embodiment 22

The method as in embodiment 21, further comprising archiving the MSS having an associated MDN to the database.

### Embodiment 23

The method as in any one of embodiments 21-22, wherein the text application server further comprises a plurality of instruction that cause a processor to perform the operations of:

registering the message from the sender; and
storing user profile data in a database accessible by the MDN application, the database having a discrete identifier linked to the message from the sender.

### Embodiment 24

The method as in any one of embodiments 21-23, further comprising providing a module for detecting an online presence of the communications device.

### Embodiment 25

The method as in any one of embodiments 21-24, further comprising providing a core resolution network that permits real-time monitoring of texts to or from the communications device by another communications device in the core resolution network.

### Embodiment 26

The method as in any one of embodiments 21-24, further comprising providing a core resolution network that enables texting between the communications device and another communications device within the core resolution network.

### Embodiment 27

The method as in any one of embodiments 21-24, further comprising providing a core resolution network

that permits real-time monitoring of texts to or from the communications device by another communications device in the core resolution network, and
that enables texting between the communications device and another communications device within the core resolution network.

### Embodiment 28

A system for resolving an MSS comprising a resolution application being configured to resolve the MSS to form a resolved MSS and display an associated MDN with the resolved MSS on a communications device.

### Embodiment 29

The system as in embodiment 27, wherein the resolution application is further configured to display a conversation list integrating the associated MDN message with the resolved MSS.

### Embodiment 30

The system as in any one of embodiments 27-29, wherein the resolved MSS comprises an MMS.

### Embodiment 31

The system as in any one of embodiments 27-29, wherein the resolved MSS comprises an SMS.

### Embodiment 32

A method for assigning a unique MDN to an entity, on a system configured to perform the method, comprising:

receiving an electronic search inquiry for a proposed MDN from the entity;
electronically searching a database of assigned MDNs for the proposed MDN;
if the searching reveals the proposed MDN does not appear in the database of assigned MDNs, adding the proposed MDN to an electronic shopping cart for the entity;
allowing the entity to purchase the proposed MDN to form an assigned MDN; and
adding the assigned MDN to the database of assigned MDNs,
thereby assigning the assigned MDN as the unique MDN to the entity.

### Embodiment 33

The method of embodiment 32, further comprising:

receiving an input from the entity configuring a communication type for engagements associated with the assigned MDN.

### Embodiment 34

The method of embodiment 33, wherein the communication type is chosen from “broadcast,” “broadcast reply,” and “broadcast converse.”

### Embodiment 35

The method of any one of embodiments 32-34, wherein the entity is a person.

### Embodiment 36

The method of any one of embodiments 32-34, wherein the entity is an organization.

### Embodiment 37

The method of any one of embodiments 32-34, wherein the entity is a company.

### Embodiment 38

A method of transmitting an engagement to a community of users, on a system configured to perform the method, comprising:
receiving, from an entity, a proposed engagement addressed to the community of users;
associating an assigned MDN belonging to the entity to the proposed engagement to form an associated engagement;
optionally receiving from the entity an input selecting a communication type to form a selected communication type and associating the selected communication type with the associated engagement; and
transmitting the associated engagement to the community of users.

### Embodiment 39

The method of embodiment 38, wherein the communication type is chosen from “broadcast,” “broadcast reply,” and “broadcast converse.”

### Embodiment 40

The method of any one of embodiments 38-39, wherein the engagement comprises an SMS message.

### Embodiment 41

The method of any one of embodiments 38-39, wherein the engagement comprises an MMS message.

### Embodiment 42

A method for a first user having a first device to monitor communications of a second user having a second device, on a system configured to perform the method, comprising:
receiving an electronic request from the first user to monitor the communications of the second user;
transmitting the electronic request to the second device for the first user to monitor the communications of the second user;
receiving an electronic acceptance from the second device accepting the electronic request; and
configuring the first device to receive the communications of the second user.

### Embodiment 43

The method of embodiment 42, after receiving the electronic request but before transmitting the electronic request, further comprising:
examining an account setting of the second user to determine whether the first user has been blocked by the second user.

### Embodiment 44

The method of any one of embodiments 42-43, further comprising: transmitting an electronic notice to the first device, the second device, or both, indicating the electronic acceptance has been received.

That which is claimed is:

1. A system for assigning unique MDNs to digital content on a communications network, the system comprising:
an engagement platform application server being configured to manage digital content by:
generating unique MDNs;
populating a database of the unique MDNs;
receiving incoming connections from a web socket in electronic communication with the communications network, at least one of the incoming connections carrying an MSS associated with one of the unique MDNs;
identifying a unique MDN from the database as an associated MDN and assigning the associated MDN to the MSS;
configuring the MSS to form a configured MSS so that the associated MDN is displayed on a communications device when the configured MSS is displayed on the communications device; and
sending the configured MSS to the communications device.

2. The system as in claim 1, wherein each unique MDN is selected from the group consisting of a logotype, a name, and combinations thereof.

3. The system as in claim 1, wherein the MSS is an SMS message addressed to the communications device.

4. The system as in claim 1, wherein the MSS is an MMS message addressed to the communications device.

5. The system as in claim 1, wherein the database of unique MDNs further comprises a user profile for each unique MDN.

6. The system as in claim 5, wherein the user profile includes a symbol, a logotype, a name, or a mark, or a combination of two or more thereof.

7. The system as in claim 5, wherein the user profile includes broadcast and reply options.

8. The system as in claim 1, wherein the configured MSS is configured to be received by a communications device chosen from a personal computer, an intelligent phone, a mobile communication apparatus, or combinations thereof.

9. The system as in claim 1, further comprising a resolution application being configured to resolve the MSS and display the associated MDN on the communications device.

10. The system as in claim 9, further comprising an incremented display including a conversation list integrating the MDN message and an SMS message.

11. The system as in claim 9, further comprising an incremented display including a conversation list integrating the MDN message and an MMS message.

12. The system as in claim 9, wherein the resolution application dictates response options to an MSS message, the response options including no response, a group response, or a private response.

13. The system as in claim 1, wherein the configured MSS is sent to the communications device via at least one outgoing connection provided by at least one web socket in electronic communication with the communications network.

14. A system for assigning discrete identifiers to digital content on a communications network, the system comprising:
a resolution application being configured to assimilate a communications device by intercepting and disassembling an MSS addressed to the communications device, the resolution application being further configured to resolve a text identifier associated with the MSS.

15. The system of claim 14, wherein the text identifier comprises an MDN.

16. The system of claim 14, wherein the text identifier does not comprise an MDN.

17. The system as in claim 14, wherein the resolution application identifies an MSS carrying an MDN.

18. The system as in claim 14, further comprising a resolution server being configured to identify an MSS containing an MDN, the resolution server in communication with the resolution application to display the MDN on the communications device.

19. The system as in claim 13, further comprising an MDN server, the MDN server being configured to associate an MSS having an associated MDN selected from the group consisting of the associated MDN's symbol, logotype, name, mark, and combinations thereof.

20. A system for assigning unique MDNs to digital content on a communications network, the system comprising:
an application server being configured to manage digital content by generating unique MDNs such that no two MDNs are identical;
a database of the unique MDNs; and
a resolution application being configured to assimilate a communications device by disassembling an MSS addressed to the communications device, the resolution application being further configured to resolve a text identifier associated with the MSS.

21. A method for managing digital content on a communications network, the method comprising:
providing an application server being configured to manage digital content by generating unique MDNs such that no two unique MDNs are identical;
providing a database of the unique MDNs;
providing a resolution application being configured to assimilate a communications device by disassembling an MSS addressed to the communications device, the resolution application being further configured to resolve an MSS having an associated MDN and process a MSS that does not have an associated MDN;
providing a resolution application server and identifying an MSS from a sender communications device having the resolution application, the resolution application server being configured to recognize whether a receiver communications device has a companion resolution application;
identifying whether the MSS from the sender communications device includes an associated MDN or is a non-MDN MSS,
wherein, if the receiver communications device has the companion resolution application and the MSS from the sender is a non-MDN MSS, the MSS from the sender communications device is processed by the resolution application server, and
wherein if the MSS from the sender communications device includes an associated MDN, the message from the sender communications device is sent to the MDN application server for processing.

22. The method as in claim 21, further comprising archiving the MSS having an associated MDN to the database.

23. The method as in claim 21, wherein the application server further comprises a plurality of instruction that cause a processor to perform the operations of:
registering the message from the sender; and
storing user profile data in a database accessible by the MDN application, the database having a discrete identifier linked to the message from the sender.

24. The method as in claim 21, further comprising providing a module for detecting an online presence of the communications device.

25. The method as in claim 21, further comprising providing a core resolution network that permits real-time monitoring of texts to or from the communications device by another communications device in the core resolution network.

26. The method as in claim 21, further comprising providing a core resolution network that enables texting between the communications device and another communications device within the core resolution network.

27. A system for resolving an MSS comprising a resolution application being configured to resolve the MSS to form a resolved MSS and display an associated MDN with the resolved MSS on a communications device.

28. The system as in claim 27, wherein the resolution application is further configured to display a conversation list integrating the associated MDN message with the resolved MSS.

29. The system as in claim 27, wherein the resolved MSS comprises an MMS.

30. The system as in claim 27, wherein the resolved MSS comprises an SMS.

31. A method for assigning a unique MDN to an entity, on a system configured to perform the method, comprising:
receiving an electronic search inquiry for a proposed MDN from the entity;
electronically searching a database of assigned MDNs for the proposed MDN;
if the searching reveals the proposed MDN does not appear in the database of assigned MDNs, adding the proposed MDN to an electronic shopping cart for the entity;
allowing the entity to purchase the proposed MDN to form an assigned MDN; and
adding the assigned MDN to the database of assigned MDNs,
thereby assigning the assigned MDN as the unique MDN to the entity.

32. The method of claim 31, further comprising:
receiving an input from the entity configuring a communication type for engagements associated with the assigned MDN.

33. The method of claim 32, wherein the communication type is chosen from “broadcast,” “broadcast reply,” and “broadcast converse.”

34. The method of claim 31, wherein the entity is a person.

35. The method of claim 31, wherein the entity is an organization.

36. The method of claim 31, wherein the entity is a company.

37. A method of transmitting an engagement to a community of users, on a system configured to perform the method, comprising:
receiving, from an entity, a proposed engagement addressed to the community of users;
associating an assigned MDN belonging to the entity to the proposed engagement to form an associated engagement;
optionally receiving from the entity an input selecting a communication type to form a selected communication type and associating the selected communication type with the associated engagement;
transmitting the associated engagement to the community of users.

38. The method of claim 37, wherein the communication type is chosen from “broadcast,” “broadcast reply,” and “broadcast converse.”

39. The method of claim 37, wherein the engagement comprises an SMS message.

40. The method of claim 37, wherein the engagement comprises an MMS message.

41. A method for a first user having a first device to monitor communications of a second user having a second device, on a system configured to perform the method, comprising:
receiving an electronic request from the first user to monitor the communications of the second user;
transmitting the electronic request to the second device for the first user to monitor the communications of the second user;
receiving an electronic acceptance from the second device accepting the electronic request;
configuring the first device to receive the communications of the second user.

42. The method of claim 41, after receiving the electronic request but before transmitting the electronic request, further comprising:
examining an account setting of the second user to determine whether the first user has been blocked by the second user.

43. The method of claim 41, further comprising:
transmitting an electronic notice to the first device, the second device, or both, indicating the electronic acceptance has been received.
